(19) United States
(12) Patent Application Publication
(10) Pub. No.: US 2022/0105527 A1
(43) Pub. Date: Apr. 7, 2022

(54) FLUID DISPENSING SYSTEM

(71) Applicant: Joseph G. Angeletta, Mamaroneck, NY (US)

(72) Inventor: Joseph G. Angeletta, Mamaroneck, NY (US)

(21) Appl. No.: 17/475,865

(22) Filed: Sep. 15, 2021

Related U.S. Application Data
(63) Continuation-in-part of application No. PCT/US2021/021612, filed on Mar. 10, 2021.
(60) Provisional application No. 62/987,556, filed on Mar. 10, 2020.
(60) Provisional application No. 63/140,498, filed on Jan. 22, 2021.

(51) Int. Cl. B05B 7/14; B05B 7/24; B65D 35/10; B65D 35/22; B65D 35/56

(52) U.S. Cl. CPC B05B 7/1422; B05B 7/24; B65D 35/56; B65D 35/22; B65D 35/10

(57) ABSTRACT

Disclosed is a fluid dispensing system useful for applying lotions and the like comprising a substantially rigid body having a hollow interior space and a discharge hole accessing the hollow interior space. A collapsible bag, disposed within the interior space and containing a fluid to be dispensed, has an open end in fluid communication with the discharge hole where an applicator is also engaged to permit the fluid to flow from the applicator. A pressure pump for increasing the pressure within the interior space to displace the fluid out of the bag and through the discharge hole thereby causing the fluid to flow from the applicator, is attached to the body. In another practice, the fluid dispensing system comprises a squeezable body having at least one vent hole.

### CROSS REFERENCE TO RELATED APPLICATIONS

This application is a continuation-in-part of PCT/US2021/021612 filed on Mar. 10, 2021, which claims benefit of U.S. Provisional Application Ser. No. 62/987,556 filed Mar. 10, 2020 and U.S. Provisional Application Ser. No. 63/140,498 filed Jan. 22, 2021, the entire contents of each of which are incorporated herein by reference.

### FIELD

The disclosure relates to a fluid dispensing system, which can be lightweight, hand-held, and portable, for applying liquids and lotions, such as, without limitation, suntan lotion, emollients, and the like.

### BACKGROUND

Heretofore, fluid dispensing systems were of complex design requiring, for example, internal plungers or handle levers to move the fluid contents forward and outward for application. Moreover, such known designs were often not easily refillable or easily exchanged to supply a different fluid, or able to supply multiple fluids. These designs were usually also prone to contamination from backflow or and the like. Additionally, they were typically of a size and design not conducive to portability. The present disclosure is directed to a fluid dispensing system that is of a size that is hand held, light weight, and easily transportable. The system comprises an internal pressure-sensitive container, such as a plastic bag, that can be conveniently refilled or exchanged for another bag containing the same or a different fluid, or that can supply multiple fluids. Moreover, contamination by impurities and drawback of the fluid to be dispensed is minimized and avoided.

### SUMMARY

In one aspect, the disclosure is directed to a fluid dispensing system that comprises a substantially rigid body having a hollow interior space. The body has at least a one discharge hole, at a first location, which first discharge hole accesses the hollow interior space. Disposed within the hollow interior space is a pressure-sensitive fluid container, e.g. a collapsible bag, for containing a fluid that is to be dispensed; the pressure-sensitive fluid container has an open end which is in fluid communication with the first discharge hole. An applicator is engaged with the first discharge hole, and in one practice houses a one-way valve for permitting the fluid to be dispensed from the pressure-sensitive fluid container to flow from the applicator without backflow. A pressure pump, such as a squeeze bulb pump or bellows pump, is attached to the body and is in fluid communication with the hollow interior space. The pressure pump, in operation, increases the pressure within the hollow interior space thereby compressing the pressure-sensitive fluid container sufficient to expel the fluid from the open end causing it to flow out the applicator.

In another practice, the disclosure is directed to a fluid dispensing system comprising a squeezable body having a hollow interior space, and a first discharge hole at a first location, the first discharge hole accessing the hollow interior space; the sqeezable body also has at least one vent hole that penetrates the body and accesses the hollow interior space. A pressure-sensitive container, e.g. a collapsible bag, for containing a first fluid to be dispensed, is disposed within the hollow interior space and has an open end in fluid communication with the first discharge hole. A first applicator engages the first discharge hole which permits the fluid to be dispensed to flow out of the collapsible bag and from the first applicator when, for example, the vent hole is covered and the body is squeezed.

### BRIEF DESCRIPTION OF THE DRAWINGS

FIG. 1A is a side view of an embodiment of the fluid dispensing system of the disclosure having a generally triangular prismatic shape comprising a substantially rigid body. FIG. 1B is s cutaway view of the embodiment of FIG. 1A. FIG. 1C is a perspective view of the embodiment of FIG. 1A.

FIG. 2 is a side view of an embodiment of a mounting plate of the disclosure.

FIG. 3A is a front view of an embodiment of the fluid dispensing system of the disclosure having a elongated handle shape comprising a substantially rigid body with variously shaped mounting plates. FIG. 3B is a side view of an embodiment of FIG. 3A. FIG. 3C is a side view of a modified version of the embodiment of FIG. 3A. FIG. 3D is a detailed partial cut away view of the top portion of the embodiment of FIG. 3C.

FIGS. 4A and 4B are perspective views of another elongated handle shape embodiment of the fluid dispensing system of the disclosure comprising a substantially rigid body and having an enlarged disc top portion.

FIG. 5 is a perspective view and partial cut way view of another elongated handle shape embodiment of the fluid dispensing system of the disclosure comprising a substantially rigid body and further comprising a canister.

FIGS. 6A and 6b are cut way side views of another elongated handle shape embodiment of the fluid dispensing system of the disclosure comprising a substantially rigid body and having inflatable bag.

FIGS. 7A and 7B are perspective and cut away views of another elongated handle shape embodiment of the fluid dispensing system of the disclosure comprising a substantially rigid body and having both an inflatable bag and a collapsible bag.

FIGS. 8A, 8B, and 8C are perspective views of another embodiment of a generally triangular prismatic shaped fluid dispensing system of the disclosure comprising a substantially rigid body and a multiplicity of fluid discharge holes. FIGS. 8D, 8E, and 8F are side views of various applicators of the disclosure that can be employed, e.g. with the dispensing system of FIGS. 8A and 8B.

FIGS. 9A and 9B are respectively a perspective view and cut away side view of another embodiment of a generally triangular prismatic shaped fluid dispensing system of the disclosure comprising a squeezable body.

FIGS. 10A and 10B are perspective views of another embodiment of a fluid dispensing system of the disclosure comprising a squeezable body. FIG. 10C is a cut-away side view of another practice of FIGS. 10A and 10B.

FIGS. 11A, 11D and 11E are side views of a collapsible bag with various annular collar embodiments of the present disclosure, with FIGS. 11B and 11D showing perspective views, and FIG. 11C showing a top view, of an annular collar embodiment. FIGS. 11F and 11G depict a pressure fit construction for the collapsible bad with annular collar. FIG. 11H is a perspective view of a spray nozzle and annular collar embodiment of the disclosure.

FIGS. 12A, 12B, 12C, and 12D are perspective views of different fluid dispensing housings of the present disclosure and various connection and dispensing means.

FIGS. 13A and 13B are full and partial side views respectively of an elbow insert embodiment of the present disclosure. FIGS. 13C and 13D are side and perspective views respectively of a tee insert for an embodiment of the present disclosure. FIGS. 13E and 13F are side views of a cross insert for an embodiment of the present disclosure.

FIGS. 14A and 14B are side views of an embodiment of self-closing dispensing valve assembly of the disclosure with FIG. 14A showing a closed first position for the valve and FIG. 14B showing an open second position of the valve. FIG. 14C is a midpoint cross-sectional view of an embodiment of a valve housing of the disclosure showing the frusto-conical passageway. FIGS. 14 D and 14E are side views of two embodiments of valve spring members of the disclosure. FIG. 14F is a perspective view showing an example of filling a collapsible fluid dispensing bag with a fluid when attached to a valve spring member of the disclosure. FIG. 14G is a side view of a prior art helically-arched valve spring. FIG. 14H is a perspective view of the valve housing of FIG. 14C showing internal features in dotted lines.

FIG. 15A is an exploded view of an embodiment of a fluid dispensing system of the disclosure employing a piercing element for mixing disparate fluids. FIG. 15B is a front view of a piercing element shaped as a toothed rod. FIG. 15C is a front view of the rod of FIG. 15B set in a dispensing connector. FIG. 15D is a top view of FIG. 15C. FIG. 15E is a cutaway view showing the interior components of FIG. 15A.

FIG. 16A is a front view of an embodiment of the fluid dispensing system of the disclosure employing a fabric cover. FIG. 16B is a disassembled front view of FIG. 16A showing the component parts. FIG. 16C is a side view of FIG. 16A; FIG. 16D is another embodiment showing a front view of loofah with sponge cover.

FIG. 17A is a cutaway view showing internal components of an embodiment of the fluid dispensing system of the disclosure showing two containers rotatably joined. FIG. 17B is a front perspective view of FIG. 17A showing the containers in a rotated position. FIG. 17C is a cutaway view showing internal components of another embodiment of two containers rotatably joined.

FIG. 17D is a front view of FIG. 17C showing the containers in a rotated position. FIG. 17E is an exploded perspective view of an embodiment wherein two containers are rotatably joined and comprise a lanyard. FIG. 17F is a side view of the rotatable connector of FIG. 17E.

FIGS. 17G and 17H are side views of the assembled rotatable embodiment of FIG. 17E in rotated positions.

FIG. 18A is a side cross sectional view of an embodiment of the disclosure for an adaptor assembly for use in a fluid dispensing system. FIG. 18B is vertical cross sectional of FIG. 18A.

FIG. 18C is a partial cross sectional cutaway view of fluid dispensing system using the adaptor assembly of FIG. 18A.

FIGS. 19A and 19B depict a cutaway and side view respectively of another embodiment of a fluid dispensing system of the disclosure having a jug-like shape.

FIG. 20A depicts a side view another embodiment of the fluid dispensing system of the disclosure having a wide mouth cap, shown in side view and perspective. FIG. 20B shows another perspective of the wide mouth cap of FIG. 20A. FIG. 20C shows another embodiment of a wide mouth cap. FIG. 20D is a side view of an embodiment of an annular collar having full external threads and a snap fit upper annular portion. FIG. 20E is a side view another embodiment of an annular collar having only partial external threads and a snap fit upper portion.

FIGS. 21A and 21B are respectively a perspective view and a front view of another embodiment of the fluid dispensing system of the disclosure having straws and a squirt top.

FIGS. 22A, 22B, and 22C are cross sectional side views of an embodiment of the fluid dispensing system of the disclosure comprising an expandable and contractable elastic balloon within which is fluid to be dispensed.

FIGS. 23A, 23B, and 23C are cross sectional side views of an embodiment of the disclosure comprising an expandable and contractable elastic balloon surround an inner collapsible bag within which bag is fluid to be dispensed.

FIG. 24 is a cross sectional side view of another embodiment of the fluid dispensing system of the disclosure comprising a canister with dip tube and a collapsible bag.

FIG. 25A is a cross sectional side view of an intermediate phase of another embodiment of a fluid dispensing system of the disclosure comprising an outer tube disposed around a collapsible bag containing a fluid to be dispensed; FIG. 25B is the another intermediate embodiment of FIG. 25A further comprising an inner tube disposed within the collapsible bag.

FIG. 26 is a cross sectional side view of a fluid dispensing system of the disclosure comprising a two collapsible bags having respective fluids to be dispensed employing the embodiments of FIGS. 25A and 25B.

FIG. 27 is a partial cross sectional side view of the embodiment of FIG. 26 showing a cap comprising two applicators.

FIG. 28 is a top down view of section A-A in FIG. 27.

### DETAILED DESCRIPTION

The description herein is made with reference to the Figures. This is for purposes of convenience only and is not restrictive to the scope of the disclosure and the practice thereof.

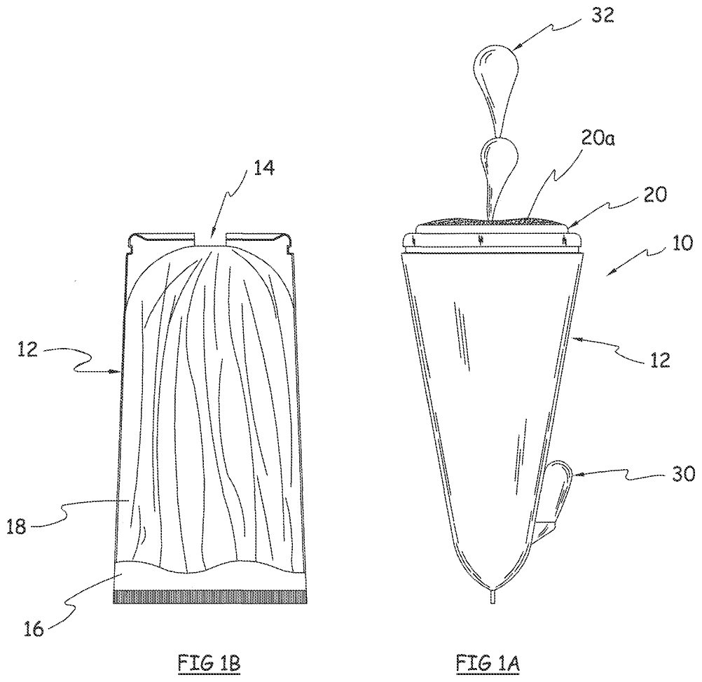

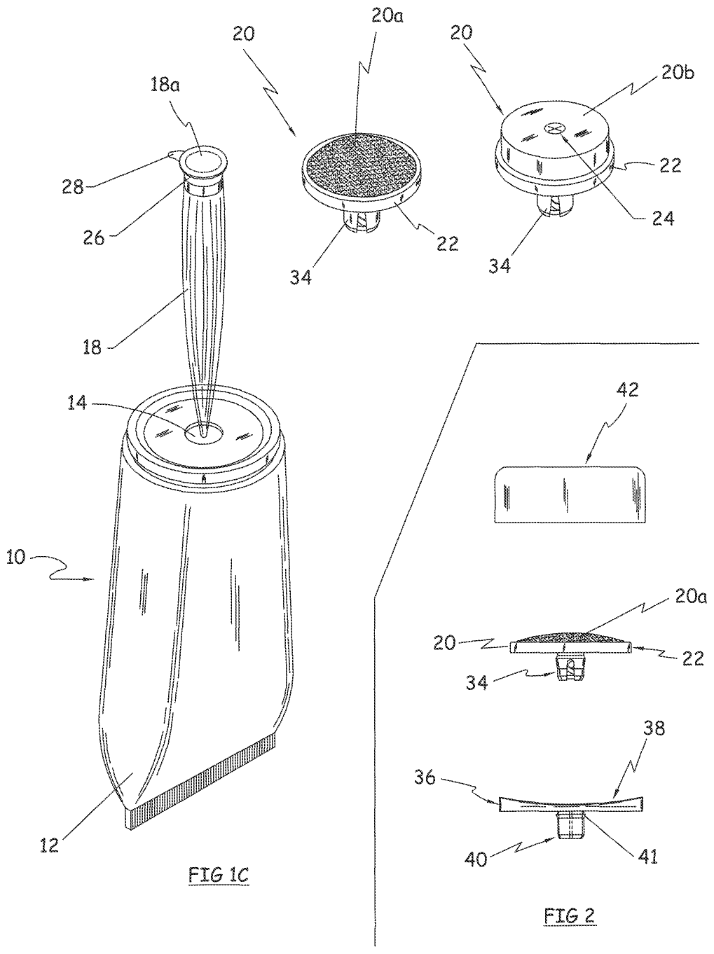

Referring to FIGS. 1A, 1B and 1C, thereat is depicted an embodiment of the fluid dispensing system 10 of the disclosure. Substantially rigid body 12, which can be of any shape, e.g. generally cylindrical, tubular (such as an elongated handle), ovate etc., including, without limitation, the shapes shown in U.S. Design Pat. Nos. D475483, D481165, D481166, D543658, D493253, D438671, D472344, D468197, and D490563, the entire contents of each are incorporated herein by reference, including derivations thereof and including the general shape of a triangular prism as shown in FIGS. 1A, 1B and 1C. Substantially rigid body 12 has hollow interior space 16 and a first discharge hole 14 which accesses the hollow interior space. A pressure-sensitive container 18 for containing a fluid to dispensed is disposed within interior space 16 and has an open end 18a that is in fluid communication with first discharge hole 14. The pressure-sensitive container can comprise, without limitation, a collapsible bag, as shown in the practice of FIGS. 1A-1C. For purposes of discussion, the embodiment of a collapsible bag will be exemplified herein, it being understood that other pressure-sensitive containers are employable. Such a collapsible bag can be impermeable and made from materials of construction selected from, without limitation, cellophane, polyethylene (e.g. low density polyethylene, linear low density polyethylene), and can be made of plant matter or oil-based materials, such as bio-bags, biodegradable plastics, edible plastics, sugar and protein based materials, plastic film, recycled and recyclable materials, laminated structures, including 2 and 3 layer systems, and the like; for food or medicinal applications, such as where the fluid to be dispensed is to be ingested or in contact with food, e.g. condiments or medicines, the material of construction for the bag is food grade and free of harmful additives; antioxidants and other additives as known in the art, e.g. ultra violet protection additives, can be present, and can be of any shape suitable for disposition within the hollow interior space, such as without limitation, a generally tubular shape as shown.

In the practices described throughout this disclosure, the pressure sensitive containers, e.g. the collapsible bags, can be inserted through the first discharge hole in an empty state, e.g. folded state, whereafter they are filled with the fluid to be dispensed once the bag is in place; they can also be refilled after use through the first discharge hole, or removed through the discharge hole and reinserted or replaced. They can also be inserted pre-filled with the pertaining fluid. The collapsible bag 18 can have an annular collar 26 attached to open end, the collar being suitably sized to create a seal against the inner walls of the first discharge hole 14 when seated in order to prevent leakage. Without limitation, the annular collar is attached to the open end of the bag around the circumferential area abutting and proximate the actual opening and extending to some distance below the actual opening along the downward length of the bag. The annular collar can be attached by methods known in the art, including e.g. by sonic welding. Optionally, the actual opening of the bag can be covered by e.g. a cover foil removable by peeling off via tab 28. Tab 28 can also be present to facilitate handling the bag when inserting it through discharge hole 14 as to situate it into interior space 16. As used herein, a substantially rigid body is one that is not squeezable to the extent that the fluid to be dispensed is expelled from the container, and includes rigid bodies, such as glass, e.g. glass jar, glass tube etc.

Representative materials of construction for the substantially rigid body include without limitation, plastics such as polyolefins, e.g. polyethylene (high and low density polyethylene), polypropylene, polyester (e.g. polyethylene terephthalate), polystyrene, polyvinyl chloride, polycarbonates, resins, plant based polymers, cardboard (which cardboard can be new or recycled; uncoated or coated e.g. with water or oil resistant materials, such as plastics including without limitation polyethylene and the like), paperboard, and the like, including single or multiple layer construction of the same or different materials of construction of suitable thickness to render the body substantially rigid or entirely rigid. In one practice, the container can be enclosed in a pouch for convenient transport, the pouch comprising a lanyard, clip (e.g. for attachment to a belt), string or other means of conveyance; the pouch can be reusable or not, and have opening means such as a zipper or not, and optionally have a flap over the operative end, e.g. a Velcro or other snug fit design near the operative end, and can comprise materials of construction that are translucent, see-through, opaque, or combinations of same. In one aspect, e.g. when the container comprises cardboard or paperboard or other such material and is contemplated for use in environments involving contact with moisture, such as in a bathroom or beach, the container, even if a waterproofed design, e.g. wax-coated cardboard, can be enclosed in a pouch which comprises materials sufficiently moisture resistant to act as a protective barrier for the container, such materials including e.g. canvas, plastic, and the like.

An applicator 20 and the first discharge hole 14 attach in fluid communication with each other by engagement methods known in the art e.g., a snap fit connection or by threads, to permit the fluid 32 to be dispensed from bag 18 and flow through the hole and from the applicator. The applicator can comprise a mounting plate 22 configured for engagement with hole 14 via connector 34 which can be configured for snap fit or thread engagement or other means known in the art with discharge hole 14 having a mating counterpart snap fit connector, threads, or other means. Applicator 20 can, but need not, comprise a one-way valve 24, or can comprise multiple such valves (e.g. two or three one-way valves), such as a duckbill valve, a ball check valve, and the like. The applicator 20 can be rotatable or non-rotatable. Applicator 20 can further comprise an applying member 20a which comprise a sponge as shown in 20a, or can comprise a brush, a squirt plug, a brush, bristles, surface-embedded rolling balls, a foam, including an open cell foam, e.g. reticulated polyurethane and the like, or a closed cell foam as shown by 20b, or combinations of any of the foregoing. The applying member 20a is affixed to the outer surface of mounting plate 22 and/or the perimeter of plate 22 by means known in the art, e.g. glue, pressure fit, a compression band. In one practice, the applying member is in fluid communication with the first discharge hole 14 through which fluid 32 is dispensed. In another practice, as shown in FIG. 2, a mounting plate 36 shown with a connector 40 having snap fitting 41, has a concave outer surface 38 which concavity serves as a reservoir for fluid to be dispensed which facilitates even flow and application of the fluid on skin or other surface. A dust cover 42 can be employed to keep the applicator clean.

Pressure pump 30 is attached to the body 12 at a pressure pump location and is in fluid communication with hollow interior space 16. Pump 30 can be attached anywhere on the surface of body 12, preferable aft of discharge hole 14 so as to optimize emptying of the collapsible bag. Operationally, pressure pump increases the pressure within the hollow interior space 16 which pressure impinges on the outer walls of bag 18 collapsing it thereby urging the fluid out of the bag and out of open end of the bag 18a to flow through applicator 20. Pressure pump 30 can be a bulb pump, as shown, or a bellows pump, or a battery operated motorized pump.

Fluids contemplated for dispensing include any flowable composition, for example and without limitation, lotions e.g. suntan lotion; oils; soaps; skin emoluments, e.g. aloe, moisturizer; creams; gels, pastes, and the like; paints, e.g. latex paints; medicaments, e.g. eyewashes and the like; and food condiments, e.g. ketchup, mustard, salad dressings, sauces and the like; milk, chocolate syrup and other syrups and flavorings.

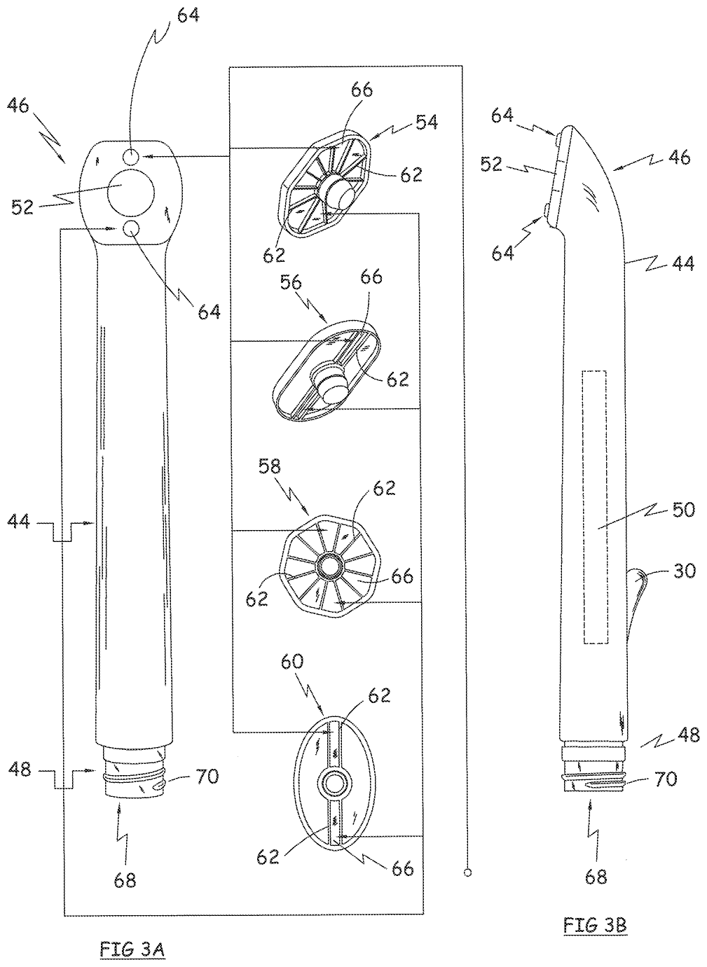

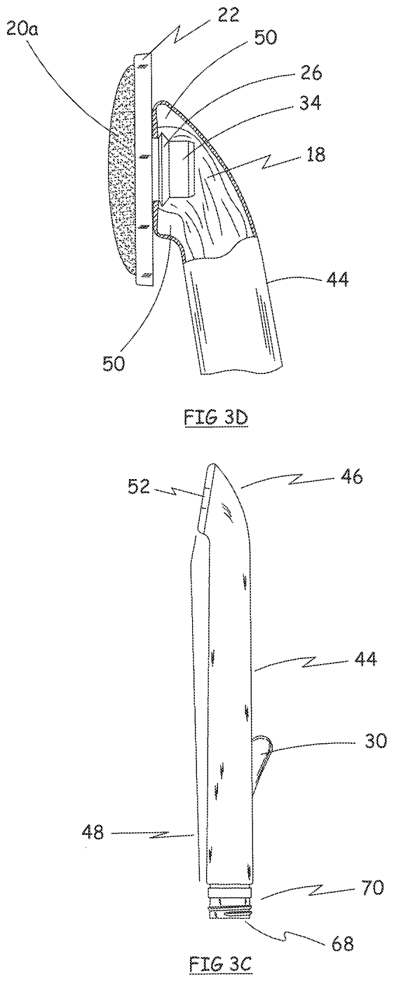

Referring to FIGS. 3A, 3B, 3C, and 3D thereat is another embodiment of the fluid dispensing system of the disclosure. In the embodiment shown, the substantially rigid body 44 is in the shape of an elongated handle, shown as a generally tubular shape, although other elongated shapes are contemplated, e.g. curved and shapes having varying widths. The elongate handle has a top portion 46 and a bottom portion 48. The hollow interior space is an interior passageway shown in part cutaway as 50 which extends between the top portion 46 and bottom portion 48. All the elongate handle embodiments discussed throughout this specification can be of hand held size and light weight, e.g. of plastic construction including by having minimally suitable wall thickness, and can have cross sections of any geometry, preferably of generally cylindrical cross section. A first discharge hole 52, which accesses the interior passageway, is located at a first location of the top portion 46. A collapsible bag 18 containing the fluid to be dispensed is disposed within the interior passageway and has an open end 18a in fluid communication with first discharge hole 52. In the practice shown, open end 18a of bag 18 is attached to connector 34 via annular collar 26. Connector 34 is attached to mounting plate 22 which has applying member 20 on its top surface.

FIGS. 3A and 3B illustrate an embodiment wherein top and bottom bosses 64 are placed proximate the discharge hole 52. FIG. 3A shows variously shaped mounting plates 54, 56, 58, and 60, which have ribs 62 on the backside. Mounting plates can be of any geometry including without limitation substantially circular. Ribs 62 delineate spaces 66 into which bosses 64 opposingly fit so as to make to mounting plate non-rotatable. FIGS. 3C and 3D show an embodiment without bosses 64 which absence permits the mounting plate and the applying member to rotate around the discharge hole 52. Pressure pump 33 is attached to the elongated handle 44 and is in fluid communication with the interior passageway 50 so that when used to pump air into the passageway, fluid will be displaced out of bag 18 and through open end 18a and out of applicator 20. Pressure pump 33 is preferably attached at or near the bottom portion, distal from discharge hole 52. As shown, a handle opening 68 is present, located at the bottom portion which handle opening accesses the interior passage; optionally external threads 70 (or internal threads, not shown) can be present to secure an end cap or other attachment.

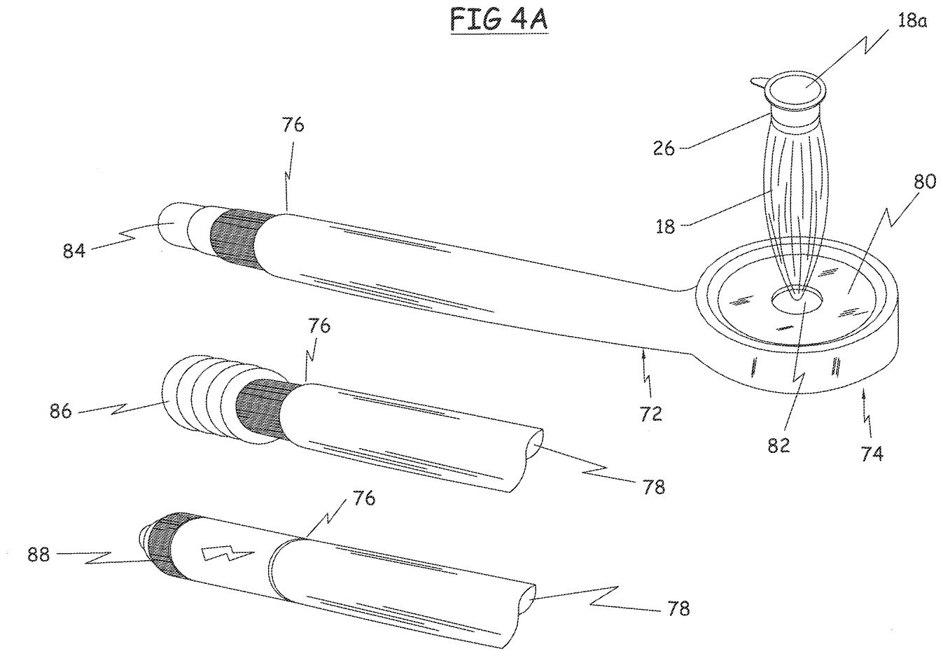

Referring to FIGS. 4A and 4B, thereat is another practice of the fluid dispensing system of the disclosure. As shown, the substantially rigid body is in the shape of an elongated handle 72 which has a top portion 74 which is in the shape of an enlarged disc, and a bottom portion 76. Interior passageway 78 extends between the top portion 74 and the bottom portion 76. Collapsible bag 18 containing the fluid to be dispensed can be inserted through first discharge hole 82 located at first surface 80 so that the open end 18a is located thereat with annular collar 26 sealing the open end 18a to the inner walls of hole 82. As shown, the pressure pump 33, shown as a squeeze bulb, can be located on the side of handle 72 proximate the top portion (FIG. 4B); or may be attached to the handle hole 90 located at the end of the bottom portion 76 and may comprise a push pump 84, a bellows pump 86 or a battery operated motorized pump 88 which are attached via external threads 92 (see FIG. 4A) although other securement means may be used.

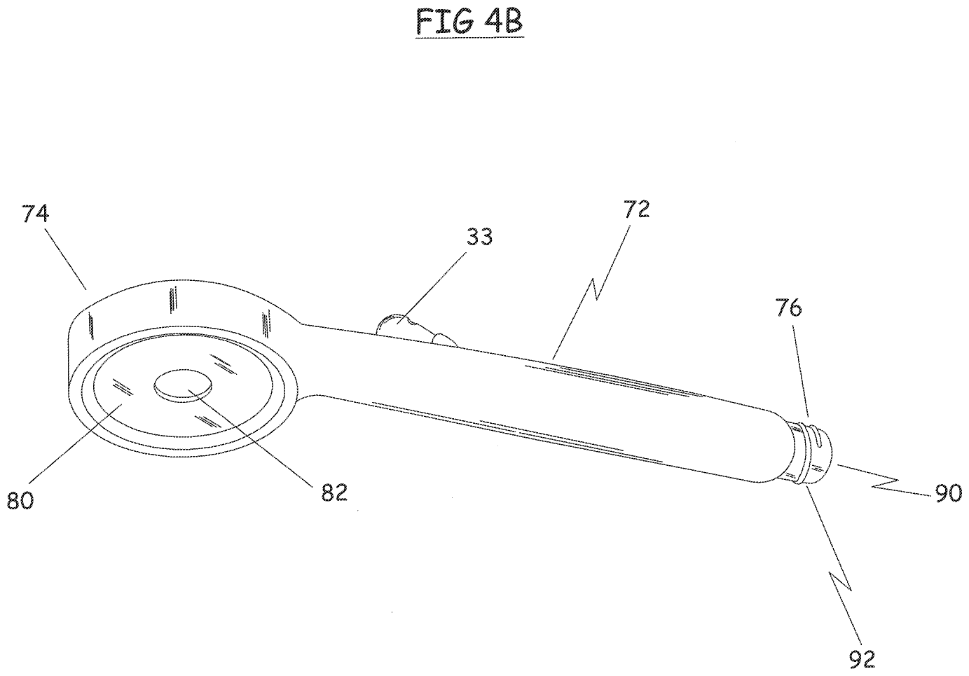

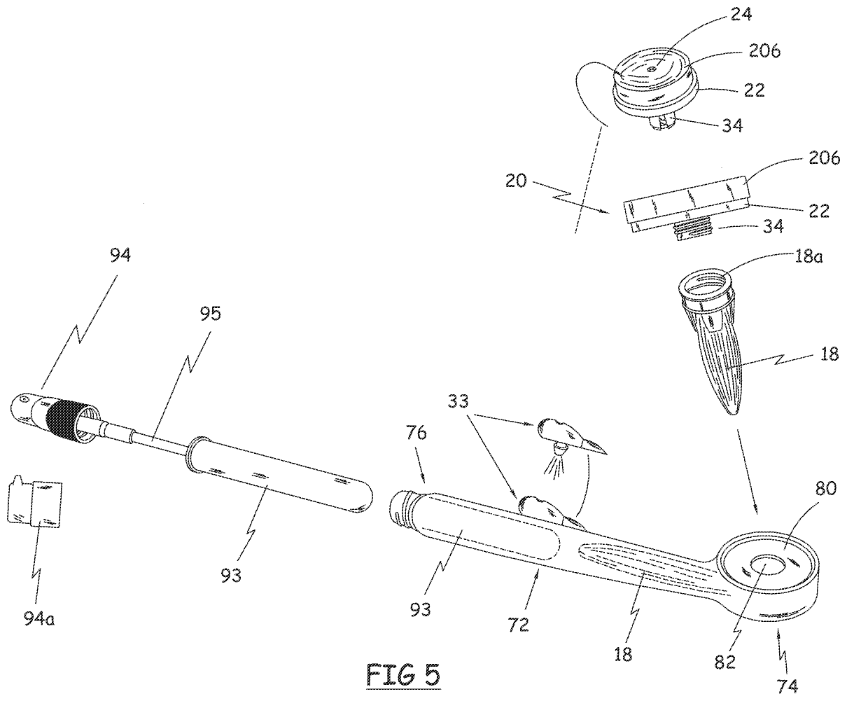

Referring to FIG. 5, thereat is another embodiment of a fluid dispensing system of the disclosure. For convenience of discussion, the embodiment shown is similar to that of FIGS. 4A and 4B to which reference is made and which has a substantially rigid body in the shape of an elongated handle 72 which has a top portion 74 in the shape of an enlarged disc, and a bottom portion 76, it being understood that the practice described for FIGS. 3A-3D, as well as other embodiments, can also be adapted to this practice. In the practice shown at FIG. 5, a rigid or semi-rigid canister 93 containing a second fluid to be dispensed, which second fluid can be the same as or different from the fluid in the collapsible bag 18, is disposed within the interior passage way in axial relation to the collapsible bag that is disposed in the part of the interior passageway nearest the top portion 74 and first discharge hole 82, this relation shown by the broken lines of 93 and 18 within elongated handle 72. That is to say, the axial relation involves the end-to-end linear alignment of the canister and the bag within the interior passageway. Canister 93 is in fluid communication, e.g. by way of dip tube 95, which extends into the second fluid, with hand pump 94, which alternatively can be a spray nozzle 94a, which is attached to the handle opening. Operationally, one can activate pressure pump 33 to expel the fluid from bag 18 through applicator 20 and/or activate hand pump 94 or nozzle 94a to dispense the second fluid from the canister.

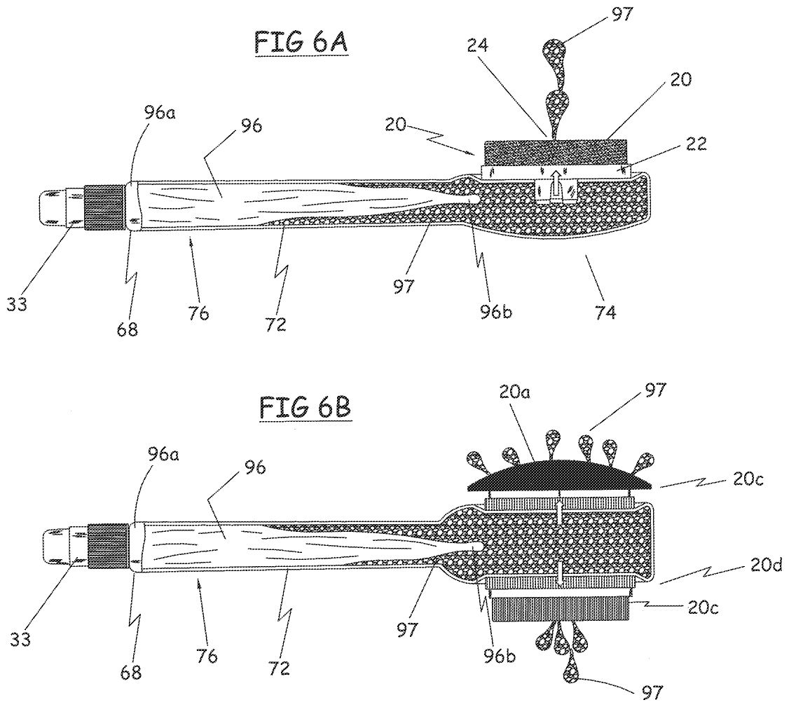

Referring to FIGS. 6A and 6B, thereat is another embodiment of the fluid dispensing system of the disclosure. For convenience of discussion, the embodiment shown is similar to that of FIGS. 4A and 4B to which reference is made and which has a substantially rigid body in the shape of an elongated handle 72 which has a top portion 74 in the shape of an enlarged disc, and a bottom portion 76, it being understood that the practice described for FIGS. 3A-3D can also be adapted to this practice. In FIG. 6A, the interior passageway of elongate handle 72 contains a fluid to be dispensed 97; that is, the fluid to be dispensed is not contained in a collapsible bag or other pressure sensitive container but instead resides directly within and in contact with the walls defining the interior passageway. In the embodiment shown, and inflatable bag 96 having an open end 96a is attached to the handle opening 68 at the bottom portion of elongate handle 72, the open end 96a in fluid communication with pressure pump 33 which is attached to the handle opening 68. Inflatable bag 96 is disposed behind and/or amid fluid 97 and has closed end 96b distal from open end 96a. Operationally, when pressure pump 33 is activated, air is pumped into bag 96 inflating it, which inflation expands the bag against fluid 97 urging it out of the applicator 20, which as depicted has a closed cell foam applying member 20b attached to the top surface of mounting plate 22. In another embodiment as shown in FIG. 6B, the elongate handle has two applicators, 20c and 20d, on opposite sides of the top portion. As bag 96 is inflated by pressure pump 33, it pushes against fluid 97 which is thereby expelled from both applicator 20c and applicator 20d. In the practice depicted, applicator 20c has a sponge as applying member 20a whereas applicator 20d has a brush 20e as the applying member.

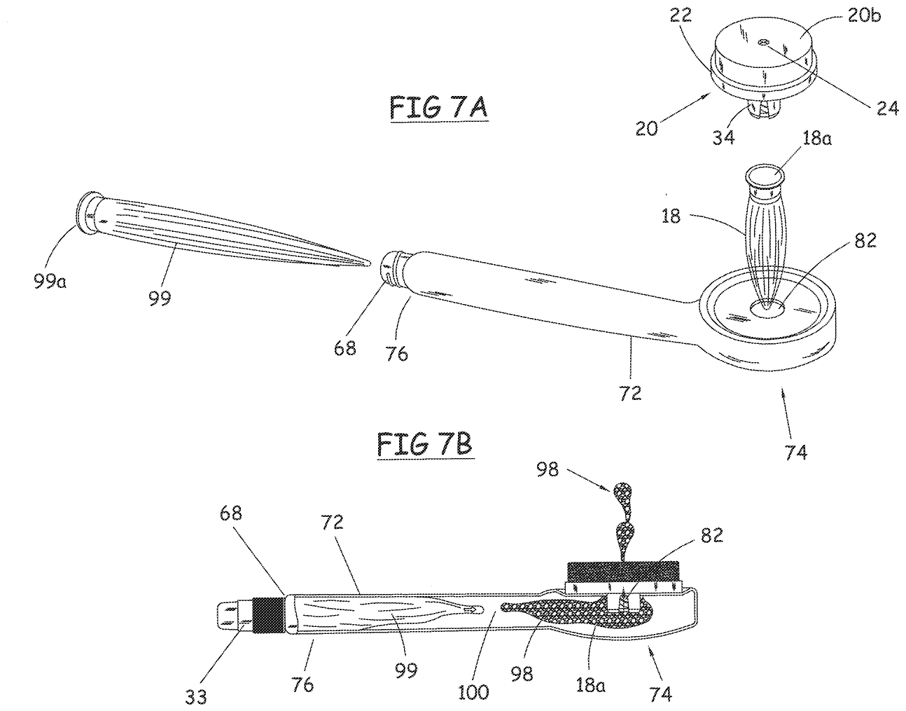

Referring to FIGS. 7A and 7B, thereat is another embodiment of the fluid dispensing system of the disclosure. For convenience of discussion, the embodiment shown is similar to that of FIGS. 4A and 4B to which reference is made and which has a substantially rigid body in the shape of an elongated handle 72 which has a top portion 74 in the shape of an enlarged disc, and a bottom portion 76, it being understood that the practice described for FIGS. 3A-3D can also be adapted to this practice. FIGS. 7A and 7B depict elongate handle 72 having an interior passageway 100 extending between bottom portion 76 and top portion 74 with first discharge hole 82 located at a first location of the top portion accessing the interior passage way. Handle opening 68 is located at the end of the bottom portion and accesses the interior passageway. Collapsible bag 18 can be inserted into the first discharge hole 82 and filled with fluid 98 to be dispensed. Inflatable bag 99 can be inserted into interior passageway via the handle hole and is situated in axial relation to fluid-containing collapsible bag 18. The open end 99a of inflatable bag 99 is in fluid communication with handle opening 68 to which is attached pressure pump 33. Operationally, when pressure pump 33 is activated, air is pumped into bag 99 inflating it against fluid-containing collapsible bag 18 urging fluid 98 out of bag 18 through first discharge hole 82 and out the applicator 20.

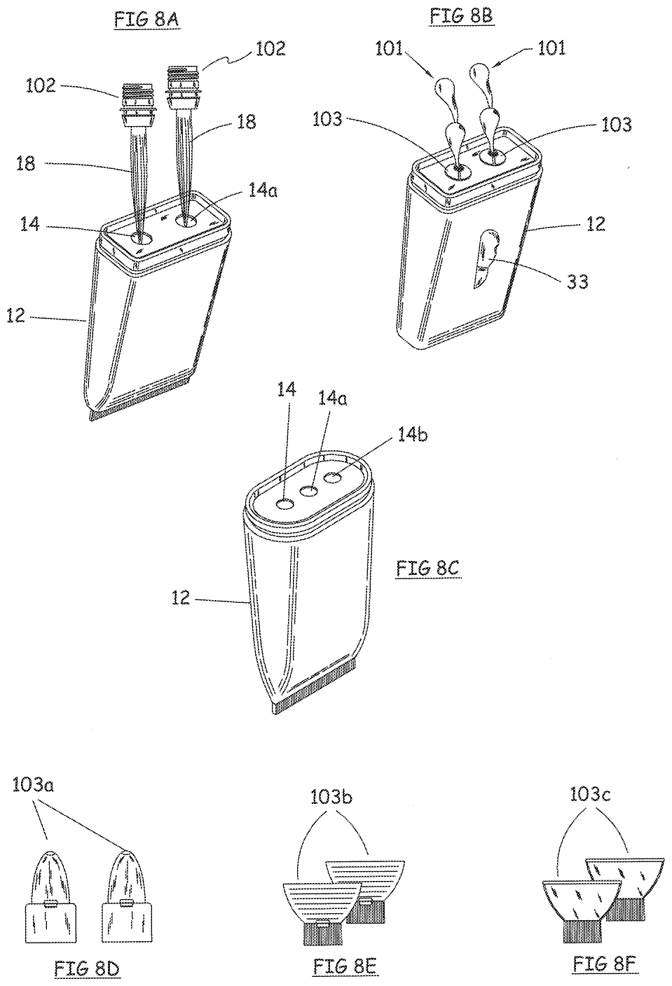

Referring to FIGS. 8A, 8B, 8C, 8D, 8E, and 8F thereat is another embodiment of the fluid dispensing system of the disclosure. For convenience of discussion, the embodiment shown is similar to that of FIGS. 1A, 1B and 1C to which reference is made. Substantially rigid body 12 is of generally triangular prismatic shape and has a hollow interior space within which is disposed a multiplicity of pressure sensitive containers, without limitation, two being depicted in the form of collapsible bags each denoted as 18 in FIGS. 8A and 8B, and three (not shown) in FIG. 8C. A multiplicity of discharge holes, denoted 14 and 14a in FIGS. 8A and 8B; and 14, 14a and 14b in FIG. 8C. The open end of each collapsible bag is in fluid communication with a respective discharge hole. Each collapsible bag is filled with a fluid to be dispensed, 101, which fluid can be the same or different for each collapsible bag. Pressure pump 33 pumps air into the hollow interior space thereby increasing the pressure therein which collapses the bags 18 and forces the fluid 101 to be expelled through the discharge holes and out of applicators 103 which are depicted as squirt plugs, but can comprise nasal sprays 103a (FIG. 8D), graduated dosage cups 103b (FIG. 8E) for where the fluid is a pharmaceutical or medicament, or eyewash cups 103c (FIG. 8F) for when the fluid is an eyewash. The open ends of bags 18 are attached to connectors 102 which in turn are attached to applicators 103.

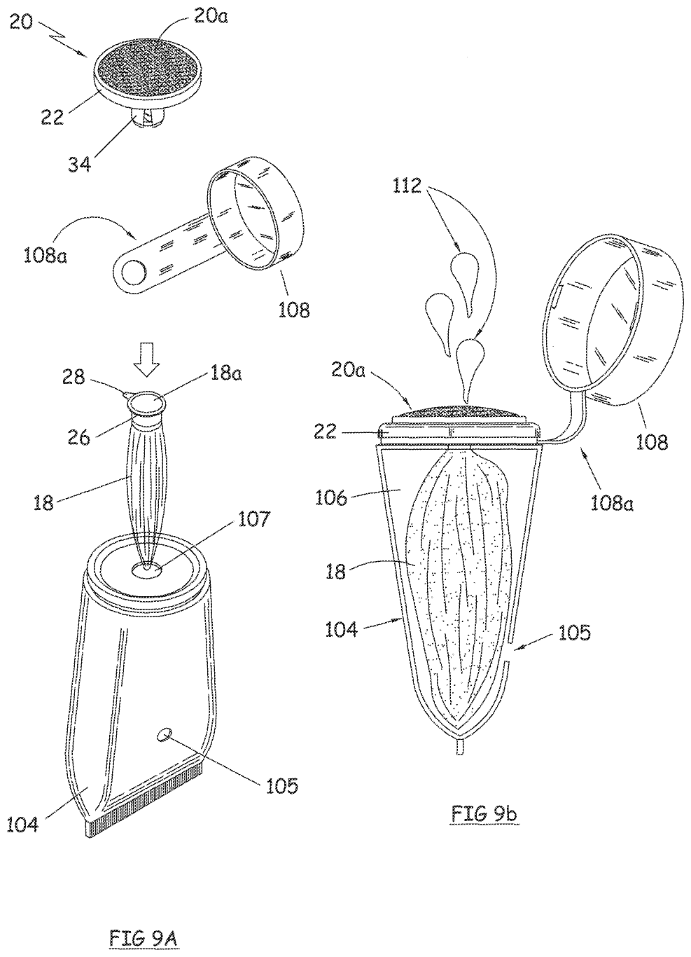

Referring to FIGS. 9A and 9B, thereat is another embodiment of the fluid dispensing system of the disclosure. As shown, squeezable body 104 is of generally triangular prismatic shape, although other shapes can be used, e.g. generally cylindrical and the like. Squeezable body 104 has a hollow interior space 106 and comprises first discharge hole 107 at a first location on the squeezable body 104, and a vent hole 105 at another location on the squeezable body 104 which penetrates body 104 and accesses hollow interior space 106; more than one vent hole may be employed and in one practice can be a series of perforations which can optionally form a design, such as letters, numbers, shapes, images and the like. The vent hole(s) may be covered with a mesh covering, such as made from a flexible fabric. A first collapsible bag 18 or other pressure sensitive container containing a first fluid to be dispensed 109 is disposed within hollow interior space 106 and has open end 18a which is in fluid communication with first discharge hole 107. As shown, bag 18 comprises annular collar 26 and tab 28. As shown, first applicator 20, having applying member 20b, engages the first discharge hole 107 via connector 34 attached to mounting plate 22 on the outer surface of which is affixed applying member 20b. Operationally, in one practice, vent hole 105 is configured such that when it is covered, e.g. by a hand or finger or other method, a seal is created so that when body 104 is squeezed, collapsible bag 18 is deformed sufficient by internal air pressure and/or by direct impingement of the inner walls of 104 against bag 18 such that fluid 112 is displaced out of the bag through open end 18a so to flow from the first applicator 20. In another practice, the vent hole is not covered and when squeezed, the inner walls of body 104 impinge on the collapsible bag urges the fluid out through the open end and applicator. Alternatively, vent hole 105 may in another practice have a pressure pump attached to it. As used herein, a squeezable body is one that is deformable by external pressure, such as applied hand and/or finger pressure, sufficient to increase the air pressure inside the hollow interior space and/or directly impinge on the collapsible bag to thereby urge the fluid to flow out of the open end of the bag and the applicator, the squeezable body resuming its original shape when the external pressure is removed. Representative materials of construction for the squeezable body include without limitation, plastics such as polyolefins, e.g. polyethylene (e.g. low density polyethylene) and polypropylene, rubber, cardboard, and the like and can be made e.g. by extrusion or blow molding, and including single or multiple layer design, all of suitable thickness to render the body squeezable. Optional dust cover 108 may be attached to the squeezable body, e.g. by tethering it to the interconnector 34 or other convenient methodology.

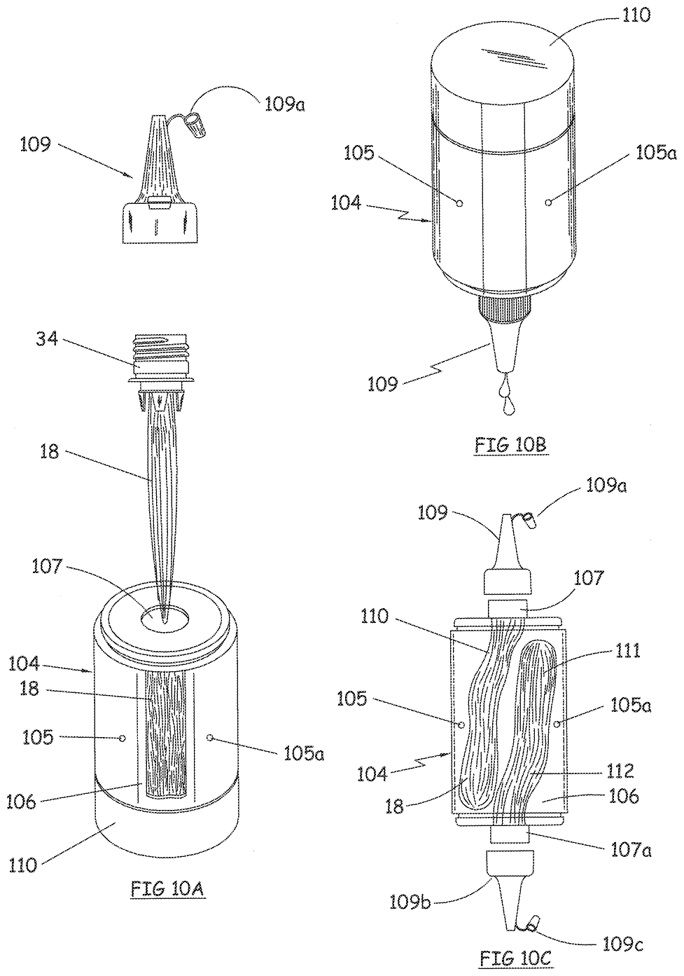

Referring to FIGS. 10A and 10B, thereat is another embodiment of the fluid dispensing system of the disclosure. For convenience of discussion, the embodiment shown is similar to that of FIGS. 9A and 9B to which reference is made. Squeezable body 104 is of generally cylindrical shape and has a hollow interior space 106 and a first discharge hole 107 at a first location on the body 104. In this practice, two vent holes 105 and 105a penetrate body 104 accessing the hollow interior space 106. As in other practices of the disclosure, a pressure-sensitive container may include a collapsible bag 18. In FIG. 10A, first collapsible bag 18 in its empty state can be inserted through hole 107 (as shown in FIG. 10A) to be disposed within hollow interior space 106 (as shown in FIG. 10A between the broken lines which delineate a partial cut away view), whereafter it can be filled with the fluid to be dispensed. Bag 18, in the practice depicted, has its open end attached to and in fluid communication with connector 34, which in turn, is attached to first applicator 109, which can be, e.g. a squirt plug that twists to an open or closed position, and can optionally have a cap 109a, and optionally, a dust cover 110 which can be sized to also fit onto the bottom, as shown in FIGS. 10A and 10B for storage during use.

Referring to FIG. 10C, thereat is another practice of the embodiment of FIGS. 10A and 10B wherein the squeezable body 104, shown as having a generally cylindrical shape although other shapes may be employed, and has a hollow interior space 106 and a first discharge hole 107 at a first location and a second discharge hole 107a at a second location, here the discharge holes are shown as being on opposite faces of squeezable cylinder 104. Two collapsible bags 110 and 111 are disposed within hollow interior space 106 with the first collapsible bag 110 having its open end attached to and in fluid communication with first discharge hole 107 and the second collapsible bag 111 having its open end attached to and in fluid communication with second discharge hole 107a. First applicator 109 engages first discharge hole 107 permitting the fluid in the first collapsible bag 110 to flow therefrom while second applicator 109b engages second discharge hole 107a permitting the fluid in the second collapsible bag 111 to flow therefrom. Applicators 109 and 109a may be the same or different. The fluid to be dispensed from first collapsible bag 110 can be the same or different from the fluid to be dispensed from the second collapsible bag 111. In one practice, the fluids in bags 110 and 111 are condiments, e.g. the fluid in bag 110 is ketchup and the fluid in bag 111 is mustard. Other fluids, including condiments, and combinations of same, can be employed.

Operationally in one practice of FIG. 10C, as an example and without limitation, the cap 109a can be removed and/or the first squirt plug 109 can be twisted to the open position while the cap 109c can remain on and/or the second squirt plug 109a can remain closed; vent holes 105 and 105a (although only one vent hole need be present) are covered by a hand or finger or other method so that a seal is created such that when body 104 is squeezed, collapsible bag 110 is deformed sufficient by internal air pressure and/or by direct impingement of the inner walls of 104 against bag 110 such that the fluid in bag 110 (e.g. ketchup) is displaced out of the bag and through squirt plug 109. The process can be reversed where, e.g. body 104 returns to its original shape after having been squeezed, cap 109a is replaced and/or squirt plug 109 is twisted to a closed position and cap 109b is removed and/or squirt plug 109c is twisted to an open position; vent holes 105 and 105a are covered by a hand or finger or other method so that a seal is created such that when body 104 is squeezed, collapsible bag 111 is deformed sufficient by internal air pressure and/or by direct impingement of the inner walls of 104 against bag 111 such that the fluid in bag 110 (e.g. mustard) is displaced out of the bag 111 and through squirt plug 109b.

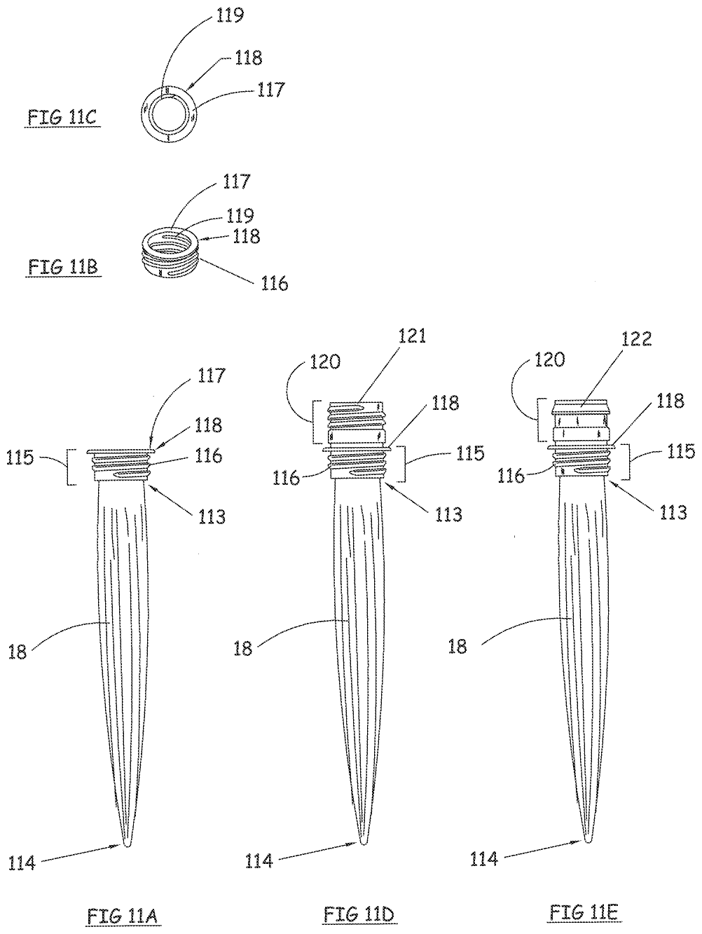

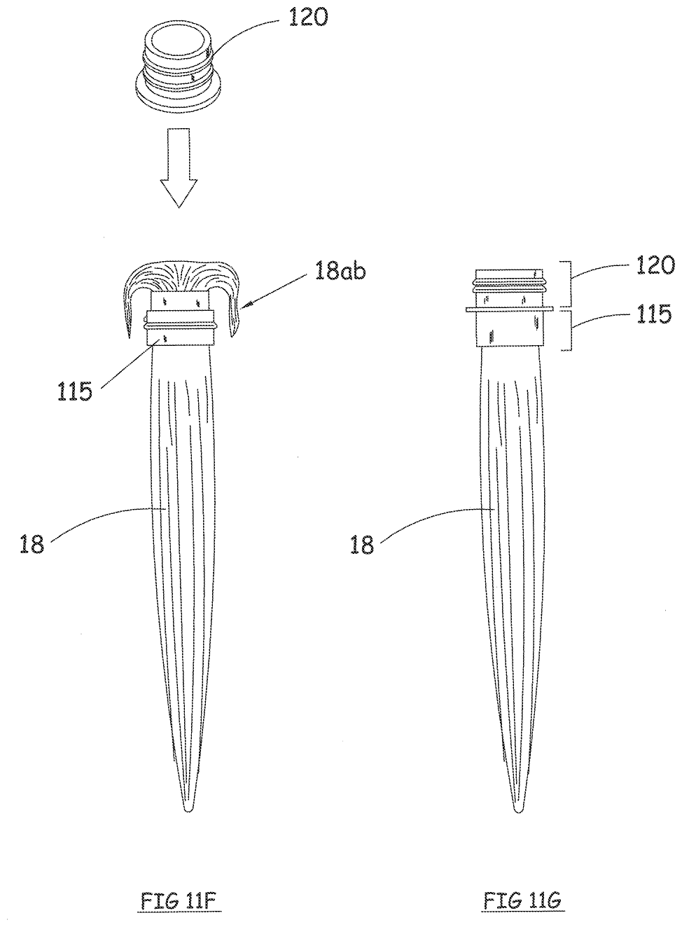

Referring to FIGS. 11A, 11D and 11E, thereat is an embodiment of pressure-sensitive fluid container comprising a collapsible bag serviceable in the practice of the fluid dispensing system of the disclosure, although useable in other environments as well. As shown, the pressure-sensitive fluid container comprise collapsible body portion, depicted as collapsible bag 18 and composed e.g. of a thin-walled plastic, which is of generally cylindrical shape and comprises an open end generally shown at 113 around which is attached annular collar 115 and a closed end 114 distal from the open end and depicted in the practice shown as being tapered. Annular collar 115 as shown has external threads 116 which in this practice are adapted to mate with threads on the wall of the discharge hole with which bag 18 is in fluid communication with. Annular collar 115 can also comprise internal threads 119 (see FIGS. 11B and 11C) which are adapted to mate with threads on either an applicator or a connector which in turn is attached to an applicator. The annular collar 115 is attached to collapsible bag 18 by means known in the art e.g. sonic welding. Optionally, annular collar 115 comprises a flange 118 which circumferential extends outwardly and can be used as a lid stop to secure the annular collar against the surface around the discharge hole so that bag 118 is properly dimensionally suspended. Annular collar 115 has a top surface 117 of annular shape.

In another embodiment, as shown in FIGS. 11D and 11E, annular collar 115 further comprises an upper annular portion 120 extending coaxially from the top surface 117. Upper annular portion 120 is in flow communication with annular collar 115 and the open end 113 of collapsible bag 18. In one practice, upper annular portion 120 comprises external threads 121 (FIG. 11D) or alternatively a snap fit connector 122 (FIG. 11E) or internal threads (not shown) which are adapted to respectively mate with complimentary internal threads or a snap fit connecter or external threads in a corresponding applicator or connector (not shown). Annular collar 115 and upper annular portion 120 can be separate pieces joined together by methods known in the art, e.g. adhesive of welding, or can be integrally formed as a unitary piece. In one practice shown in FIGS. 11F and 11G, bag 18 is pressure fit into annular collar 115 and upper annular portion 120, e.g. FIGS. 11F and 11G depict bag 18 having been pulled through annular collar 115 with excess bag portion 18a being folded over annular collar 115 whereafter upper annular portion 120 is fitted onto annular collar 115 and over that part of bag 18ab that was folded over; excess bag may be trimmed to fit. In the practice shown, annular collar 115 has external threads adapted to mate with internal threads on the upper annular portion 120, which further comprises external threads for adaption to a dispenser.

In one exemplary practice, shown in FIG. 11H, collapsible bag 18 has annular collar 115 with internal threads 119 which are adapted to mate with external threads 124 on dispensing pump 123 (shown in side view) when bag 18 is disposed within the body of the fluid dispensing system of the disclosure. Dip tube 125 extends into bag 18 and into the fluid to be dispensed. Alternatively, as shown in FIG. 11H, a spray nozzle 123a (shown in front view) with external threads 124a and dip tube 125a can be employed. In other embodiments, upper annular portion 120 can independently comprise external threads, internal threads, or a snap connect fit connector; and annular collar 115 can independently comprise external threads, internal threads, or a snap fit connector.

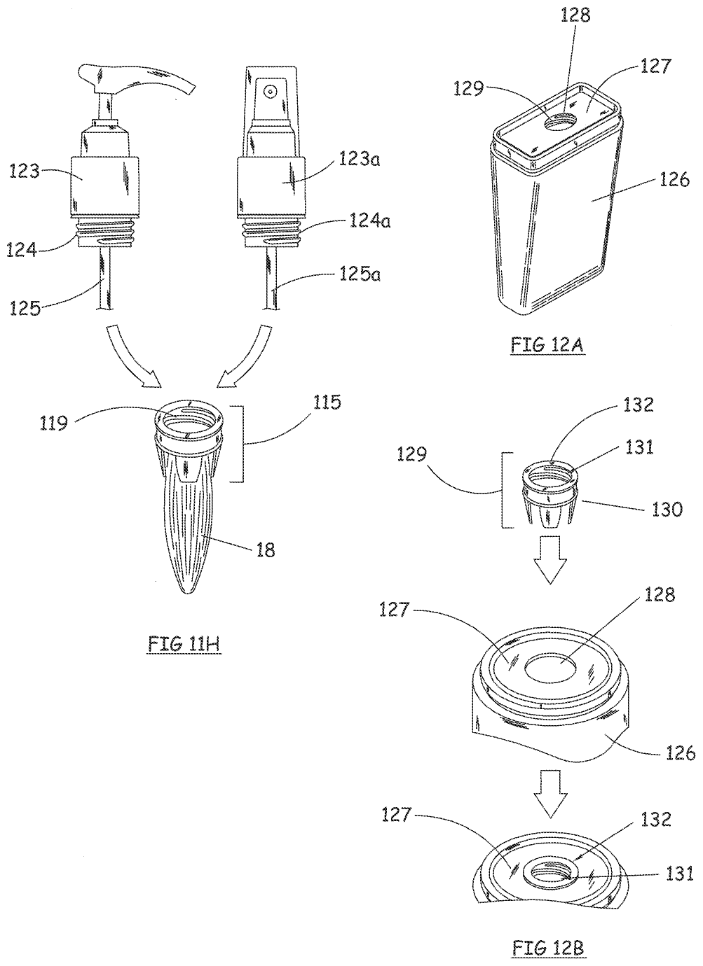

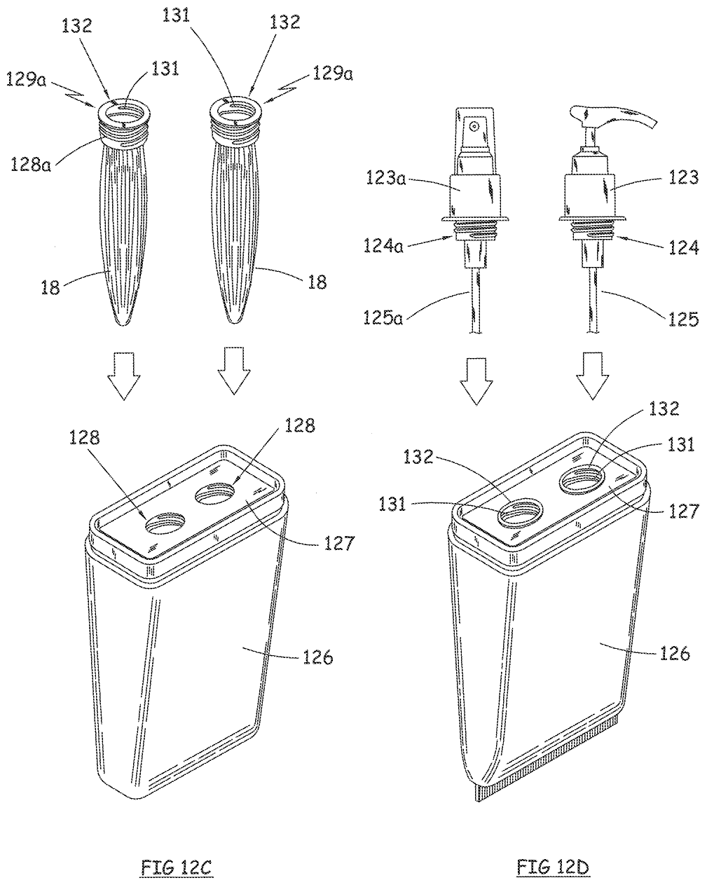

Referring to FIG. 12A, thereat is an embodiment of a fluid dispensing housing serviceable in the practice of the fluid dispensing system of the disclosure, comprising a substantially rigid body 126 in the general shape of a triangular prism, although other shapes may be used, comprising a substantially planar top body surface 127, a first discharge hole 128 whose walls have internal threads 129. In one practice, body portion 126 is blow molded and the discharge hole 128 and threads 129 are part of the mold and formed during the blow molding. FIG. 12C depicts a fluid housing comprising substantially rigid body 126 with two blow molded holes each designated 128 having internal threads 129, it being understood that a multiplicity of such holes can be present, each having a collapsible bag containing a fluid for dispensing.

Referring to FIG. 12B, thereat is another embodiment of a fluid dispensing housing comprising a substantially rigid body 126 shown as having a generally cylindrical shape, although other shapes may be employed, comprising a substantially planar top surface 127 and a first discharge hole 128, this hole not having threads along its walls, but rather merely penetrating the body 126. Annular collar 129 (with bag not shown) comprises a snap-fit portion 130 and a threaded portion 131 which can comprise internal threads (as shown) or external threads (not shown) which are configured to accommodate an applicator for the dispensing system, and flange 132. In the practice depicted, annular collar 129 is snapped into hole 128 which is configured to mate with the snap fit portion 130. Flange 132 sits on top surface 127 and acts as a lid stop. FIG. 12C depicts container 126 configured for two collapsible bags, 18, and annular collars 129a with external threads 128a that screw into the container discharge hole which in this practice comprises threads adapted to mate with threads 128a. FIG. 12D depicts the embodiment of FIG. 12C once the bags are disposed within the interior cavity of container 126. FIG. 12D depicts a fluid housing comprising substantially rigid body 126 with two annular collars having internal threads 131 and flanges 132 acting as lid stops on surface 127, it being understood that a multiplicity of such holes with annular collars, which can be the same of different as described herein, can be present, each having a collapsible bag containing a fluid for dispensing. In the practice shown, spray nozzle 123a with dip tube 125a and external threads 124a adapted to mate with threads 131 is inserted into one of the discharge holes; and pump dispenser 123 with dip tube 124 and external threads adapted to mate with threads 131 is inserted into the other discharge hole. In other practices, instead of threads 131, 124, 124a, snap connections can be used, as well as various combinations of same.

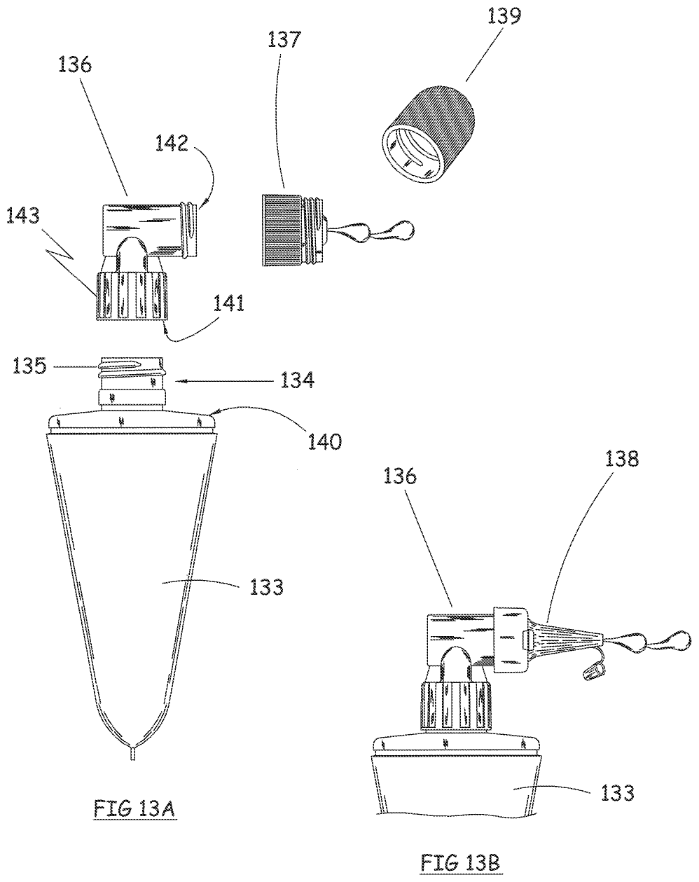

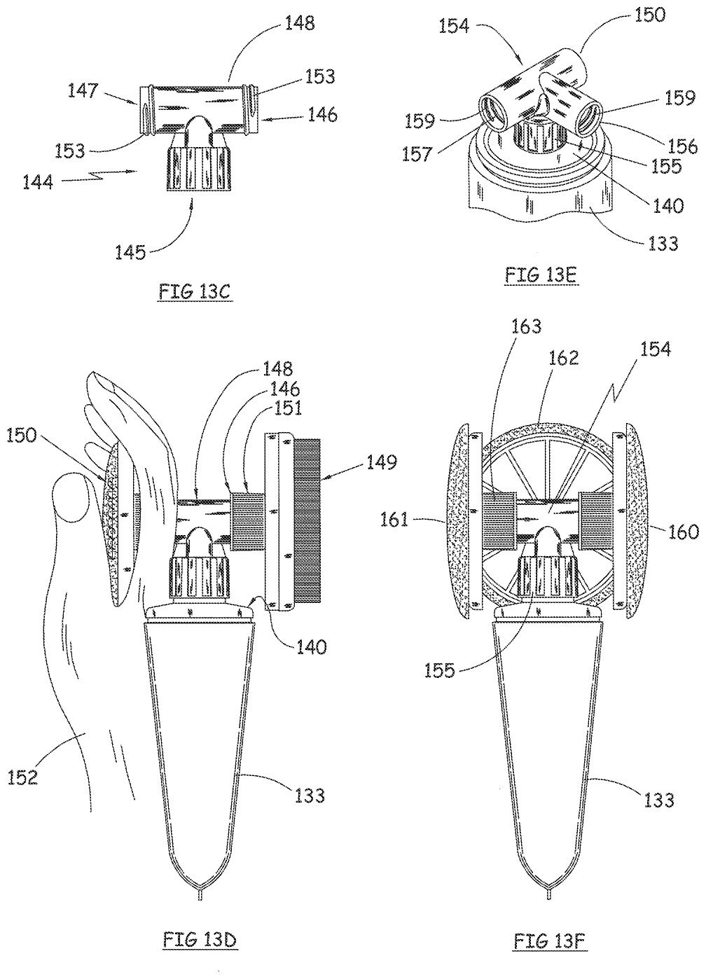

Referring to FIGS. 13A and 13B, thereat is another practice of the fluid dispensing system of the disclosure. Substantially rigid body 133 (which in any of FIG. 13 can be of any shape, including an elongated handle shape as herein described) with upper annular portion 134 of the annular collar having external threads 135 and which upper annular portion 134 extends coaxially above the top surface 140, the top surface being substantially planar. Elbow insert 136 is attached between the first discharge hole (here, in the practice shown, elbow insert 136 is attached directly to the upper annular portion 134 via fitting 143 which cane, e.g., comprise internal threads, where annular portion 134 is, in turn, part of the annular collar which is attached to the discharge hole; inlet fitting 143 can be integrally formed as part of elbow insert 136 or can be a separate rotatable piece that forms part of insert 136 and capable of being screwed onto the upper annular portion 134, for example) and the first applicator 137, shown as a pad, and provides a flow path for fluid to be dispensed between the first discharge hole and the applicator, generally the path between the elbow inlet 141 and the elbow outlet 142. The elbow inlet 141 and elbow outlet 142 of elbow insert 136 can be at an angle of about 85° and about 150° relative to each other, or alternatively, relative to the plane 140 of first discharge hole. In one practice, the angle is about 90° as shown in FIGS. 13A and 13B. FIG. 13B shows a variation on the applicator, a squirt plug being depicted.

At FIGS. 13C and 13D, is another embodiment wherein the insert is a tee (“T”) insert 144 comprising an tee inlet 145 which attaches to the first discharge hole of substantially rigid body 133, and a first tee outlet 146 which attaches to a first applicator 149 in this embodiment, and a second tee outlet 147 which attaches to a second applicator 150, which second applicator 150 can be the same or different from the first applicator 149. In the practice shown in FIG. 13D, the applicators are attached via applicator fittings 151 which have internal threads which mate to external threads 153 on the outlets 146 and 147, although other connection methods, e.g. snap fit, external threads etc., as described herein may also be used. In one practice, the first tee outlet and the second tee outlet are set at an angle of about 180° relative to each other. In another practice, the length of the planar tee outlet portion 148 is sufficient to permit a hand 152 to be placed under an applicator for use, as shown in FIG. 13D. At FIGS. 13E and 13F is yet another embodiment wherein the insert is a cross insert 154 which comprises an inlet (not shown as obscured by fitting 155) that attaches to the first discharge hole of substantially rigid body 133, and a first cross outlet 156 which attaches to a first applicator 160, a second cross outlet 157 which attaches to a second applicator 161, and a third cross outlet which attaches to a third applicator 162. The first, second, and third applicators can be the same or different. As shown in FIG. 13E, the first, second, and third cross outlets 156, 157, 158 have internal threads 159 which are respectively adapted to mate with external threads on the first, second, and third applicators, 160, 161, and 162, although other connection methods may be used, e.g. snap fit, or external threads, as depicted in FIG. 13F wherein applicator fittings 163 have internal threads adapted to mate with external threads on the cross outlets. In one practice, as shown in FIGS. 13E and 13F, the second cross outlet 157 and the third cross outlet 158 are disposed at an angle of about 180°, and the second cross outlet 157 and the third cross outlet 158 are each individually at an angle of about 90° relative to the first cross outlet 156. In another practice (not shown), the first cross outlet 156 and the second cross outlet 157, and the second cross outlet 157 and the third cross outlet 158, and the third cross outlet 158 and the first cross outlet 156 are each respectively at an angle of about 120°.

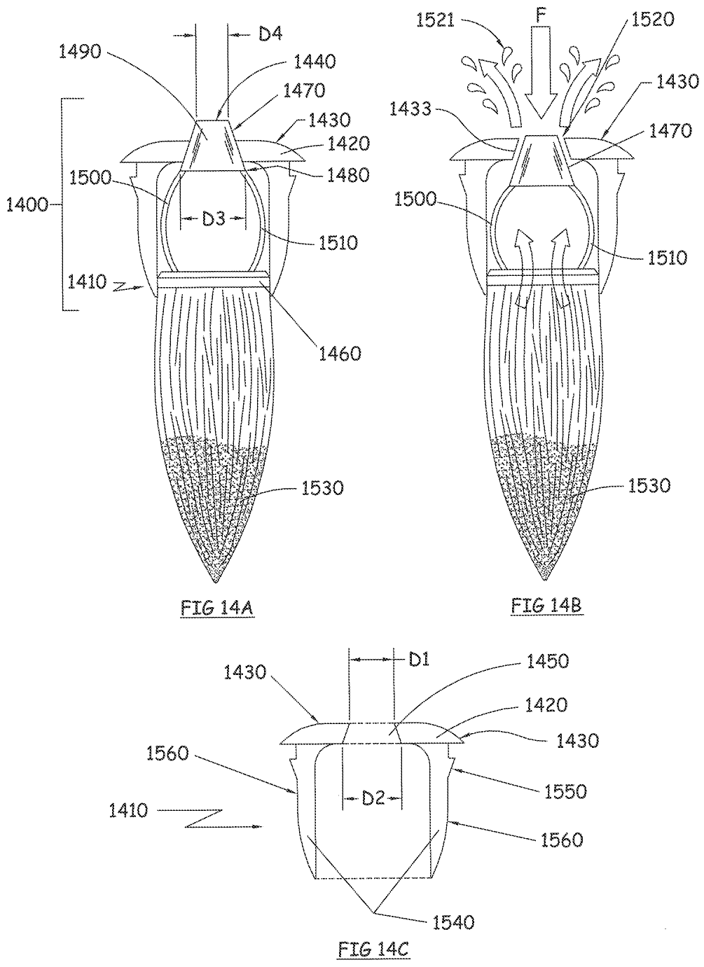

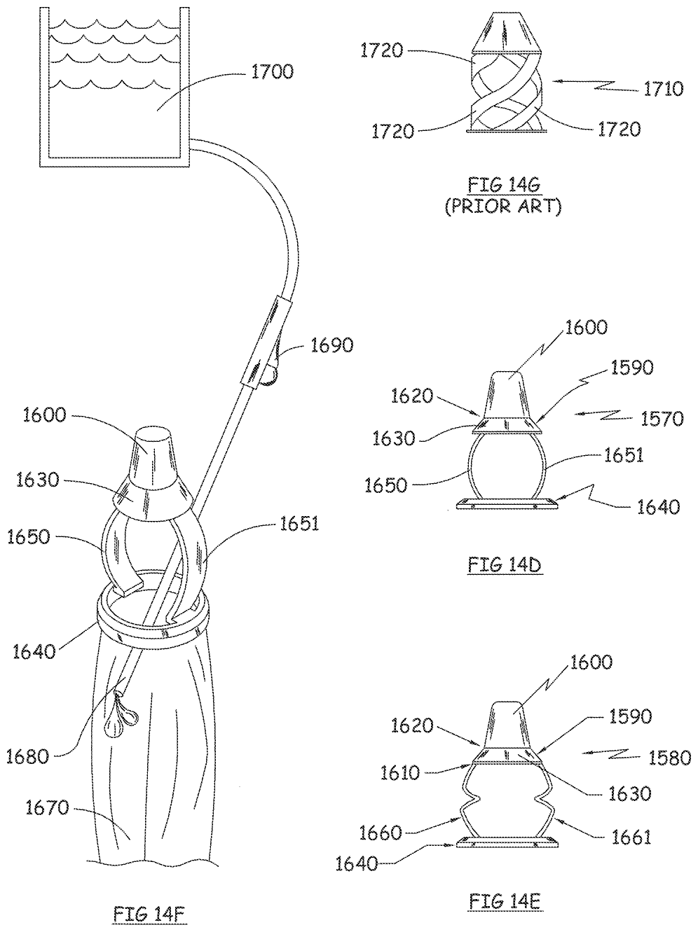

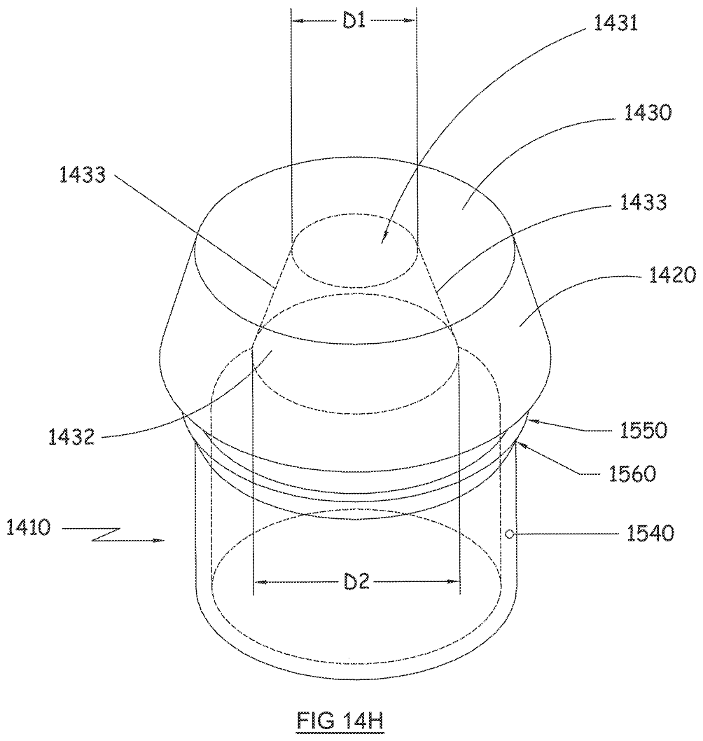

Referring to FIGS. 14A and 14B, thereat is an embodiment of a self-closing dispensing valve assembly 1400 of the disclosure. The assembly comprises a valve housing 1410, shown in midpoint cross sectional view in FIG. 14C and in perspective in FIG. 14H. As shown in FIGS. 14C and 14H, valve housing 1410 comprises a top portion 1420 which can be circular, e.g. disc-shaped, or other geometric shape. Top portion 1420 has top surface 1430 and has a circular fluid inlet hole 1432 having a diameter indicated by “d2” in FIGS. 14C and 14H, and a circular fluid outlet hole 1431 having a diameter indicated by “d1” in FIGS. 14C and 14H, the diameter of the circular fluid outlet hole is smaller than the diameter of the circular fluid inlet hole (d1<d2). The circular fluid inlet hole and the circular fluid outlet hole are connected by a frusto-conical fluid passageway 1450, defined by wall 1433, that extends through top portion 1420. In the practice shown, the narrow end of the frustro-conical fluid passageway 1450 is the circular fluid outlet hole 1431 having diameter d1 and the wide end is the circular fluid inlet hole 1432 having diameter d2.

Valve housing 1410 is configured to be attached to a fluid dispensing system including without limitation, those described herein. Referring to FIGS. 14C and 14H, in the practice depicted, without limitation, the valve housing 1410 can comprise an annular wall 1540 which extends downwardly from at or proximate to the perimeter of top portion 1420. In one practice, the outside surface 1560 of wall 1540 can be configured to attach the valve housing 1410 to a fluid dispensing system. In FIGS. 14C and 14H, outside wall surface 1560 comprises snap fitting 1550 which extends partly or entirely around the circumference of annular wall 1540. Snap fitting 1550 is adapted to mate with a complementary snap connector located on the fluid dispensing system; in an alternative embodiment (not depicted), the outside wall surface can comprise external threads which are adapted to mate with complementary threads of a fluid dispensing system. Other methods of attachment are contemplated by the disclosure. As shown in FIGS. 14A and 14B, the valve housing is attached to collapsible fluid dispensing bag 1530 which contains a fluid to be dispensed.

Disposed within valve housing 1410 is a spring valve member comprised of a frustro-conical section 1490, an annular base 1460, a first non-helical arch 1500, and a second non-helical arch 1510. In the spring valve practice shown in FIGS. 14A and 14B, frustro-conical section 1490 has an upper surface 1470, a wide end, generally indicated at 1480, which wide end has a diameter indicated as “d3” which is greater than the diameter d1 of the circular fluid outlet hole 1431 thereby keeping frustro-conical section 1490 from exiting the circular fluid outlet hole 1431. Frustro-conical section 1490 also comprises a narrow end, generally indicated at 1470 which, in the practice depicted in FIGS. 14A and 14B, comprises closed narrow top end 1440, and which has a diameter indicated as “d4” which is less than the diameter d1 of the circular fluid outlet hole 1431. As illustrated in FIGS. 14A and 14B, the frustro-conical section 1490 is configured so that at least a portion of its upper surface 1470 sealingly fits within the frustro-conical passageway 1450 of the valve housing 1410, e.g., the upper surface 1470 is configured to nest in whole or in part so that it seals against enough of the wall 1433 of the frustro-conical passageway 1450 so as to prevent fluid flow out the circular fluid outlet hole 1431.

Operationally, in the practice depicted in FIGS. 14A and 14B, the frustro-conical section 1490 is displaceable along an axis from a first position shown in FIG. 14A to a second position shown in FIG. 14B. In the first position of FIG. 14A, the closed narrow end 1440 protrudes above the circular fluid outlet hole 1431 of the valve housing and at least a portion of the frustro-conical upper surface 1470 is in contact with the frustro-conical passageway, e.g. in sealing contact with wall 1433 that defines the frustro-conical passageway, to obstruct the flow of the fluid to be dispensed from bag 1530 so that is does not flow through and out of circular fluid outlet hole 1431. In the second position shown in FIG. 14B, the frustro-conical section 1490 is moved inward toward the circular fluid outlet hole 1431, this movement being responsive to force F applied downwardly to the closed narrow end 1440 such as applied by a finger or by pressing closed end 1440 against a surface onto or into which the fluid to be dispensed is to be applied, e.g. by pressing closed end 1440 against the skin to apply a lotion. In the second position, the upper surface 1470 of the frustro-conical portion 1490 has been displaced downward by force F into the valve housing 1410 and away from the wall 1433 defining the frustro-conical passageway so that the frustro-conical section does not obstruct the flow of fluid over the upper surface 1470 and through and out the circular fluid outlet hole 1431 as shown by fluid drops 1521.

In the practice depicted, the frustro-conical section 1490 is displaced such that gap 1520 forms between the wall 1433 of the frustro-conical passageway and the upper surface 1470 of the frustro-conical section sufficient to permit fluid 1521 to egress the circular fluid outlet hole 1431. In one practice, the fluid 1521 is propelled through the fluid outlet hole 1431 by pressure exerted against collapsible fluid dispensing bag 1530 such as e.g. when the collapsible fluid dispensing bag is disposed within the hollow interior of a rigid body or other body or housing as described herein and a pressure pump in fluid communication with that hollow interior increases the pressure within the hollow interior space to displace the fluid out of the bag. The pressure in these practices can be dynamic, e.g. the pressure pump is being constantly activated, e.g. pumped, while the fluid is being dispensed, or static, e.g. where the pressure pump is activated only to increase the pressure whereafter the pumping stops and the fluid is dispensed using whatever pressure is present in the hollow interior space. In an alternative practice, no pressure pump is present or if present is not activated, and the fluid is dispensed via gravity, e.g. in FIG. 14B, the self-closing dispensing valve assembly is inverted to such that the circular fluid outlet hole 1431 is angled sufficiently downward so that when force F is applied, e.g. by tapping the closed end 1440 against a surface, the fluid 1521 flows though and out the circular fluid outlet hole 1431 via gravity. In this practice the collapsible fluid dispensing bag 1530 may be present or absent, e.g. the fluid to be dispensed may reside within the hollow interior space per se and not in a collapsible bag.

FIG. 14D depicts an embodiment of a spring valve member 1570 contemplated by the disclosure comprising a frustro-conical section 1630 having an upper surface 1590 and an upwardly protruding button portion 1600; a wide end, generally at 1610 and a narrow end, generally at 1620; an annular base 1640; a first non-helical biasing arch 1650 having a first end connected to the annular base 1640 and a second end connected to the wide end 1610 of the frustro-conical section, and having a second non-helical biasing arch 1651 which has a first end connected to the annular base 1640 and a second end connected to the wide end 1610 of the frustro-conical section; the second non-helical biasing arch 1651 is located directly opposite the first non-helical biasing arch 1650. In the practice shown in FIG. 14D, the first and second non-helical biasing arches 1650, 1651, are each individually bowed outward so that each arch has a substantially C-shaped cross-sectional profile; in one aspect, as depicted in FIG. 14D, the midpoint of each arch extends beyond the diameter of the wide end 1610 of the frustro-conical section. In the embodiment illustrated at FIG. 14E, the first non-helical biasing arch 1660 and the second non-helical biasing arch each individually have a substantially W-shaped cross-sectional profile. In another embodiment (not shown), the first and second non-helical biasing arches can each individually have an accordion-shaped cross-section profile.

FIG. 14G shows a prior art version of a valve member 1710 having three helical arches 1720. Such helical arches have been found to impede the filling or refilling of a collapsible fluid dispensing bag, as shown e.g. in FIG. 14E using a filling tube 1680 and control valve 1690 to fill or refill collapsible dispensing bag 1670 from reservoir 1700, which can be a container or other receptacle holding the fluid to be dispensed in bulk. The collapsible dispensing bag 1670 can be in or out of the fluid dispensing system while being filled or refilled. In either case, as shown in FIG. 14E, the filling tube 1680 can be easily and straightforwardly placed to sit between non-helical biasing arches 1650 and 1651 whereas with the prior art spring valve member 1710 of FIG. 14G, the twisted shape of the helical arches and the number of such arches, e.g. three or more such arches, causes entanglements with the filling tube and constricts the amount of space available to insert the filling tube.

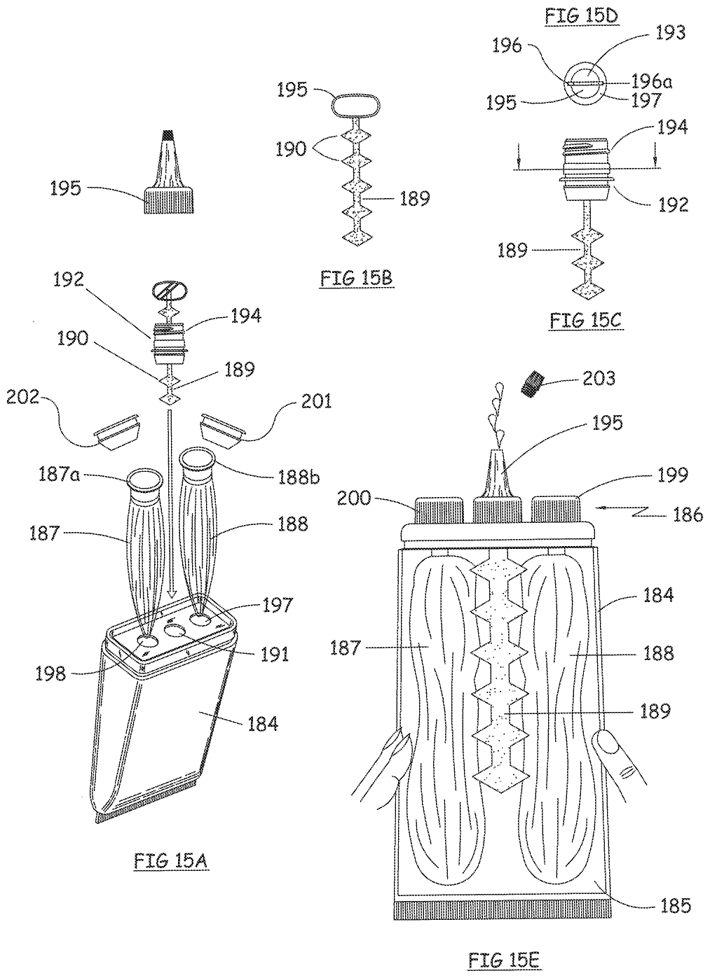

Referring to FIGS. 15A, 15B, 15C, 15D, and 15E, thereat is an embodiment of the fluid dispensing system of the disclosure enabling mixing of different fluids. Squeezable container 184 comprises hollow interior space 185 and dispensing end 186. In one practice, at least two perforable bags, first perforable bag 187 and second perforable bag 188, are housed within the hollow interior space 185, each bag containing a different fluid. A piercing element 189 is situated between bags 187 and 188 so as to be able to puncture each bag when container 184 is squeezed whereupon the different fluids are released into and mixed in the hollow interior space. The mixed fluid is then dispensed through the dispensing end 186. As illustrated, piercing element 189 is suspended from the dispensing end and extends into the hollow interior space. The piercing element can be a rod, e.g. either flat or cylindrical, and can comprise one or more outwardly projecting teeth, as depicted, or any other structures known in the art capable of puncturing the bags. The squeezable container 184 and bags 187 and 188 can be of any suitable shape. For example, bags 187 and 188 can be of the same or different shapes and as illustrated are each of substantially tubular shape and of the same general size and dimensions. The piercing element 189, shown as a straight rod although other shapes can be used, extends at least partly along the length of the tubular shaped bags, preferably along a substantial part or along all or even beyond the length of the tubular bags.

Squeezable body 184 comprises a dispensing hole 191 which penetrates the body and is in fluid communication with the hollow interior portion 185. A dispensing connector 192 is sealingly fit into the dispensing hole 191. The dispensing connector when placed is in fluid communication with the hollow interior portion by way of e.g. the dispensing connector has a passageway, e.g. a bore therethrough, and further comprises an upper open portion 194 that is outwardly projecting from the dispensing end. The upper end portion 194 is in fluid communication with the dispensing connector 192, e.g. by way a bore that extends through the upper open portion, which bore can align with the bore through of the dispensing connector. The upper open portion 194 can be separately attached to the dispensing end 192 or can be integrally formed as a unitary piece with the dispensing end. As shown, nozzle 195 with optional removal cap 203 can be attached to the upper open portion of the dispensing connector, although other applicator members, e.g. closed cell foam etc., as described herein can be optionally employed. The piercing element 189, shown as a rod in the practice depicted, can be suspended from the dispensing connector 192. In one practice, dispensing connector 192 comprises a ledge 197 extending radially inwardly from the inner walls of the passageway or bore as shown in FIG. 15D, which is a top view through the dotted line in FIG. 15C. In one practice, the rod 189 has an upper end comprising a transverse member 195 which can be a cross bar or loop as shown or other configuration. The transverse member 195 has ends 196 and 196a that sit on ledge 197 thereby suspending the rod 189 so that it extends into the hollow interior space 185 of squeezable container 184. The ledge can comprise slots on opposing sides of the ledge into which the ends 196 and 196a of the transverse member 195 can be seated so as to limit movement and provide stability to the rod. Other configurations and methods of suspension can be employed. The piercing element, e.g. rod 189, can be removable. In the embodiment shown, the dispensing end 186 further comprises a first entry hole 197 and a second entry hole 198, each of which penetrate the body 184 at dispensing end 186 and each individually access the hollow interior space.

In the embodiment depicted, without limitation, the dispensing hole 197 is interposed between the first and second entry holes 197, 198, as shown where holes 197 and 198 straddle hole 191 whereby all three holes, 191, 197, 198, are substantially in linear alignment across the face of dispensing end 186. First perforable bag 187 has its open end secured to the first entry hole 198 by way of connector 202 which sealingly fits into hole 198 including by way of snap fit or threads as described herein, and optionally has a bore therethrough to put it in fluid communication with the hollow interior space if desired. In the practice shown, first perforable bag 187 has a seal 187a over the open end to close it thus preventing the fluid within from egressing. Similarly, second perforable bag 188 has its open end secured to the first entry hole 197 by way of connector 201 which sealingly fits into hole 197 and optionally has a bore therethrough to put it in fluid communication with the hollow interior space if desired. In the practice shown, second perforable bag 188 has a seal 188a over its open end to close it thus preventing the fluid within from egressing. First and second removable caps 200 and 199 can be placed over first and second entry holes 198 and 197 respectively.

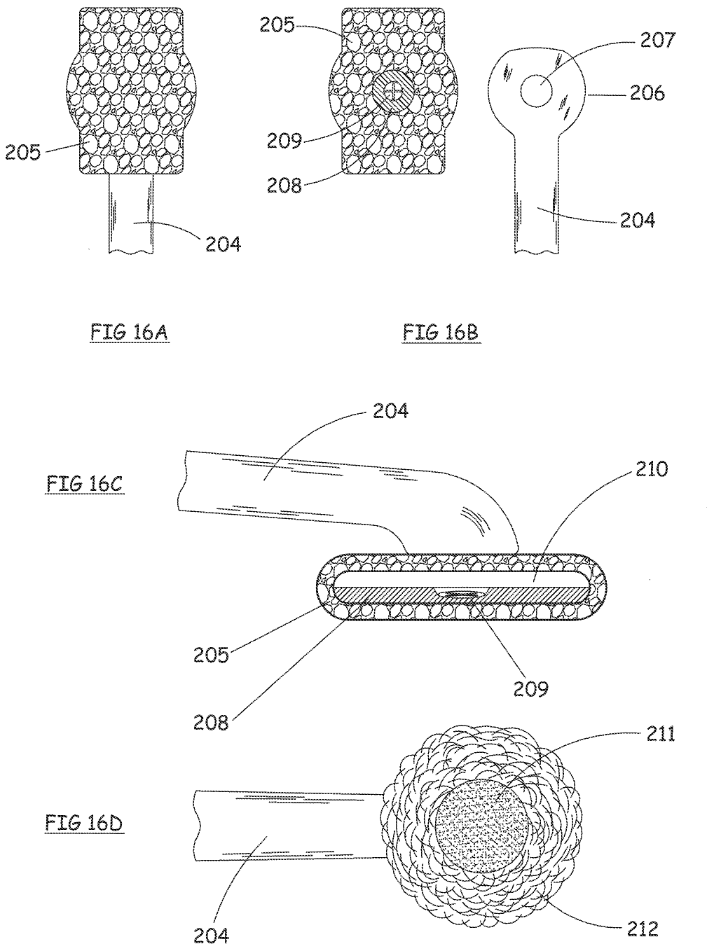

Referring to FIGS. 16A, 16B, 16C, and 16D, thereat is another practice of the fluid dispensing system of the disclosure wherein the applicator further comprises a fabric cover. In the embodiment shown, the substantially rigid body is shown for convenience as an elongated handle 204, it being understood that this is not limiting and that other body shapes, e.g. triangular prisms etc., are employable as well. In the practice shown, elongated handle 204, which comprises an interior passageway into which is disposed a fluid-containing collapsible bag as hereinbefore described, see e.g. FIGS. 3 and 4, with top portion 206 and discharge hole 207 into which is fitted a connector (not shown; see e.g. FIG. 3C) which is attached to mounting plate 210 which mounting plate has applying member 208, shown without limitation in FIGS. 16B and 16C as a closed cell foam, on its top surface, although other types of applicator members can be used. A one way check valve 209 housed, e.g., in the mounting plate, can optionally be present. In the embodiment shown, fabric cover 205 is over the mounting plate and closed cell foam applicator member, although other configurations are useable, e.g. the fabric cover can be placed over the entirety of the top portion and the mounting plate, e.g. where the fabric cover is in the form of a stretchable band. The fabric cover can comprise materials of construction that assist in the application of the fluid to be dispensed, e.g. lotions. Without limitation, such materials include comprise a pile cloth or a looped cloth, such as terry cloth, a loofah sponge, a synthetic material and the like. In one practice, shown in FIG. 16D, the applicator member is a foam 211 and a fabric such as a loofah sponge 212 surrounding the outer edge of the foam applicator 211 to cover only the periphery of the foam 211 such that when the fluid is applied, both the foam 211 and the loofah sponge 212 are in contact with the skin during application.

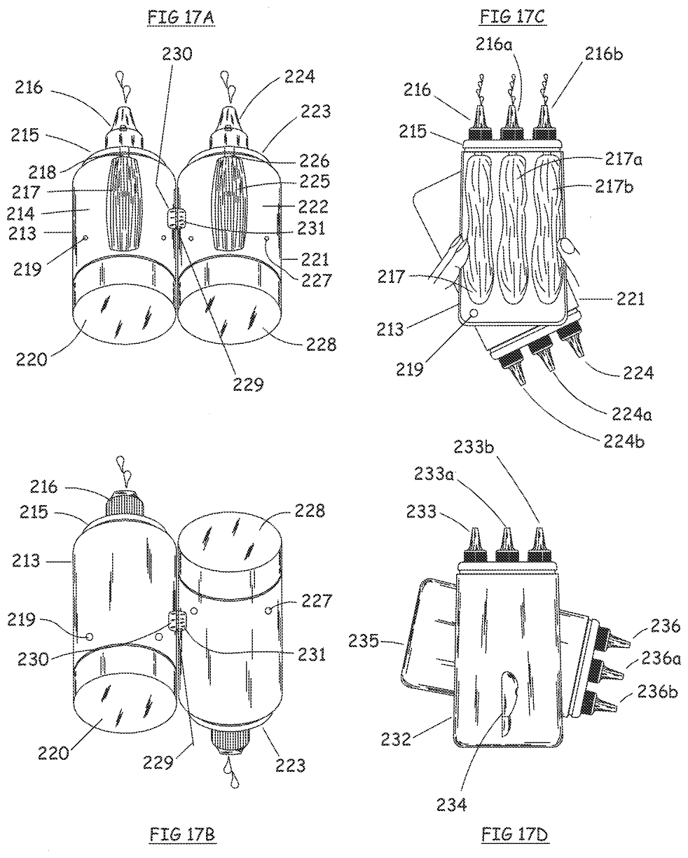

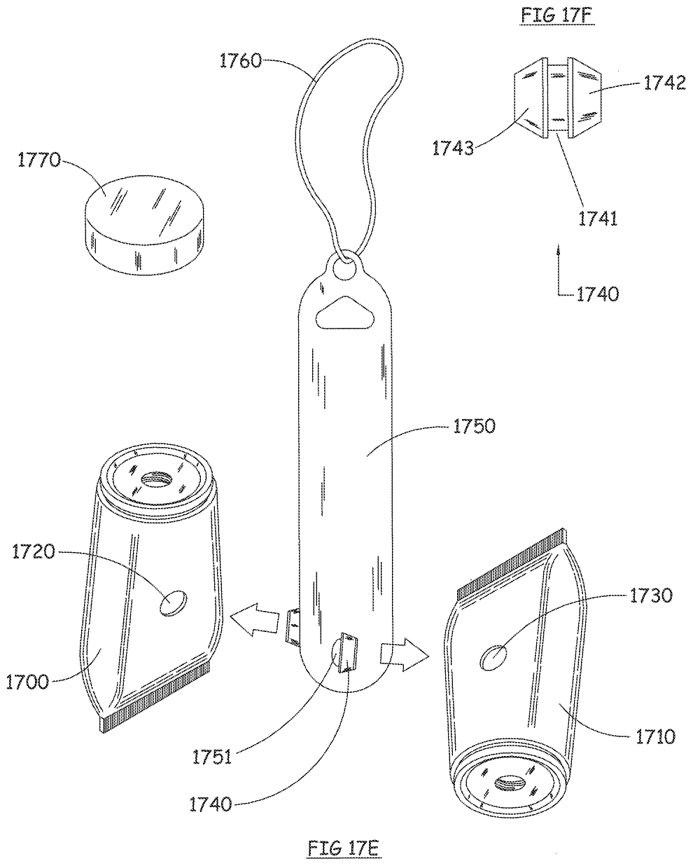

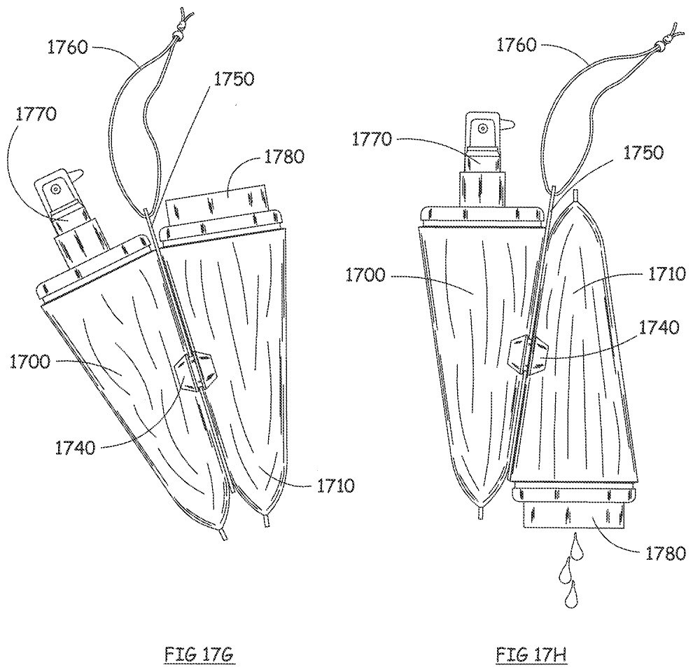

Referring to FIGS. 17A, 17B, and 17C, thereat is another embodiment of the fluid dispensing system of the disclosure comprising a first body 213 that is squeezable and has a first body dispensing end 215 comprising one or more first body nozzles 216, with one such nozzle being shown in the practice of FIGS. 17A and 17B, and three nozzles 216, 216a, 216b being shown in the practice of FIG. 17C. First body 213 has a first body hollow interior space 214 and one or more collapsible bags 217 disposed within the first body hollow interior space 214, with one such bag being shown in the practice of FIGS. 17A and 17B, and three such bags 217, 217a, 217b being shown in the practice of FIG. 17C., with each bag containing the same fluid or with at least one bag containing a fluid that is different from the others or with all bags each containing a different fluid. Each bag is in respective and individual fluid communication with one of the first body nozzles as described herein, e.g. via connector 218 which has a bore therethrough so that the nozzle and bag are in fluid communication with each other, and whereby when the first body is squeezed, the fluid from each of the one or more collapsible bags is dispensed individually through its respective first body nozzle. First body 213 has one or more optional vent holes 219. Each first body nozzle comprises an open and closed position and/or a removable cap to control which fluids are to flow from the first body. Preferably, two perforable bags are present, as shown in FIGS. 17A and 17B, with each bag 217 and 225 containing a different fluid.

Still referring to FIGS. 17A, 17B, and 17C a second body 221 that is squeezable and has a second body dispensing end 223 comprising one or more second body nozzles 224, with one such nozzle being shown in the practice of FIGS. 17A and 17B, and three nozzles 224, 224a, 224b being shown in the practice of FIG. 17C. Second body 221 has a second body hollow interior space 222 and one or more collapsible bags 225 disposed within the second body hollow interior space 222, with one such bag being shown in the practice of FIGS. 17A and 17B, and three such bags (not shown in FIG. 17C as obscured by first body 213), with each bag containing the same fluid or with at least one bag containing a fluid that is different from the others or with all bags each containing a different fluid. Each bag is in respective and individual fluid communication with one of the first body nozzles as described herein, e.g. via connector 226 which has a bore therethrough so that the nozzle and bag are in fluid communication with each other, and whereby when the first body is squeezed, the fluid from each of the one or more collapsible bags is dispensed individually through its respective first body nozzle. Second body 221 has one or more optional vent holes 227. Each second body nozzle comprises an open and closed position and/or a removable cap to control which fluids are to flow from the first body. Preferably, two perforable bags are present, as shown in FIGS. 17A and 17B, with each bag 217 and 225 containing a different fluid. The body 213 and the second body 221 can be of different sizes or can be of substantially the same size and shape, e.g. cylindrical. The first body 213 and the second body 221 can each comprise corresponding flat surfaces 220 and 229 respectively that can be aligned so that they are coplanar, as shown in FIG. 17A, whereby on which aligned flat surfaces the fluid dispensing system comprising both the first and second bodies 213 and 221 can stand, e.g. when placed on a table or shelf.

Connector 229 rotatably attaches the first body 213 to the second body 221 so that the first and second bodies can rotate axially relative to each other around connector 229 as shown in FIG. 17A wherein the first and second bodies 213 and 221 are in an upright position, and then in FIG. 17B wherein the second body 221 has been rotated around connector 229 so that its dispensing end 223 is opposite the dispensing end 215 of first body 213. This configuration allows flexibility in dispensing the respective fluids, e.g. food condiments and the like. Connector 229 can be located anywhere along the sidewalls of first body 213 and second body 221, preferably about the midpoint of the body length as shown in FIGS. 17A and 17B where the bodies are of cylindrical shape and are substantially the same size. In one practice, rotatable connector 229 comprises a bore therethrough from side 230 to its opposite side 231 whereby the first body hollow interior 214 and the second body hollow interior 222 are in fluid communication with each other such that when either one of the other of the first body 213 or second body 221 is squeezed the air in the body being squeezed will pass through connector 229 to collapse the bags in the other body and dispense the pertaining fluid therefrom. For example, if first body 213 is squeezed, the increased pressure will collapse bag 217 sufficient to dispense the fluid therein through first body nozzle 216 while at the same time air will flow from first body 213 through connector 229 into second body 221 to collapse bag 225 sufficient to dispense the fluid therein through second body nozzle 224. Both fluids can thus be dispensed or one can select which of the two fluids is dispensed by opening or closing or capping the first body nozzle 216 or the second body nozzle 224.

FIG. 17D illustrates another embodiment of this rotatable practice wherein the first body 232 and the second body 235 are both substantially rigid, wherein the first body 232 has a first body hollow interior space and the second body has a second body hollow interior space (the interior spaces not shown in FIG. 17D) and each body has a dispensing end comprising, as shown, one or more first body nozzles, 233, 233a, 233b on the first body 2323, and one or more second body nozzles 236, 236a, 236b on the second body 235 (a three nozzle practice for each being depicted in FIG. 17D), each of which nozzles have open and closed positions and/or a removable cap. As with the squeezable body practice described above: one or more collapsible bags (not shown) are disposed in the first body hollow interior space and, separately, one or more collapsible bags (not shown) are disposed in the second body hollow interior space, with each bag containing the same fluid or with at least one bag containing a fluid that is different from the others or with all bags each containing a different fluid. Each bag is in respective and individual fluid communication with one of the first body nozzles as described herein, e.g. via a connector (not shown in FIG. 17D) which has a bore therethrough so that the nozzle and bag are in fluid communication with each other, and whereby when the first body is squeezed, the fluid from each of the one or more collapsible bags is dispensed individually through its respective first body nozzle. The first body 232 comprises a first body pressure pump 234 located on its surface and in fluid communication with the first body hollow interior space.

Referring to FIGS. 17E, 17F, 17G, and 17H, thereat is another embodiment of a rotatable practice of the disclosure showing containers 1700 and 1710 rotatably attached by connector 1740 which can have bore therethrough and which is connected to a lanyard 1750. Lanyard 1750 has a hole 1751 configured to fit around groove 1741 which extends around the periphery of the middle of connector 1740 to secure the lanyard to same. Frustro-conical ends 1742 and 1743 are respectively inserted into holes 1730 and 1720 of containers 1710 and 1700. String 1760 is connected to an end of the lanyard 1750 for carrying or storage purposes, e.g. hanging off a hook. One or more dust caps 1770 and optionally be snapped onto the container for protection. FIGS. 17G and 17H shows an assembled version of this embodiment wherein container 1700 comprises a spray nozzle 1770 and container 1710 comprises an applicator, FIG. 17H being in a position rotated relative to FIG. 17G.

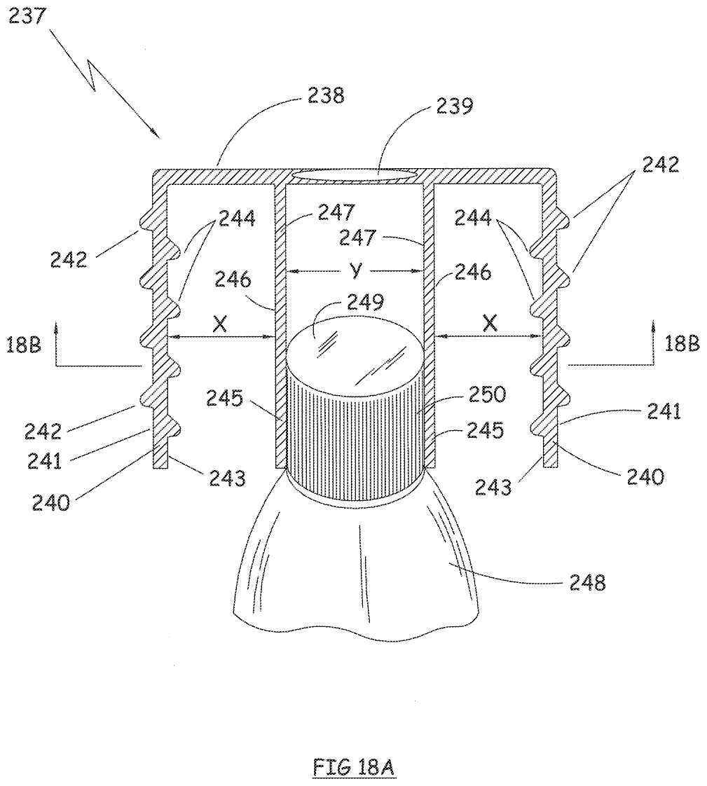

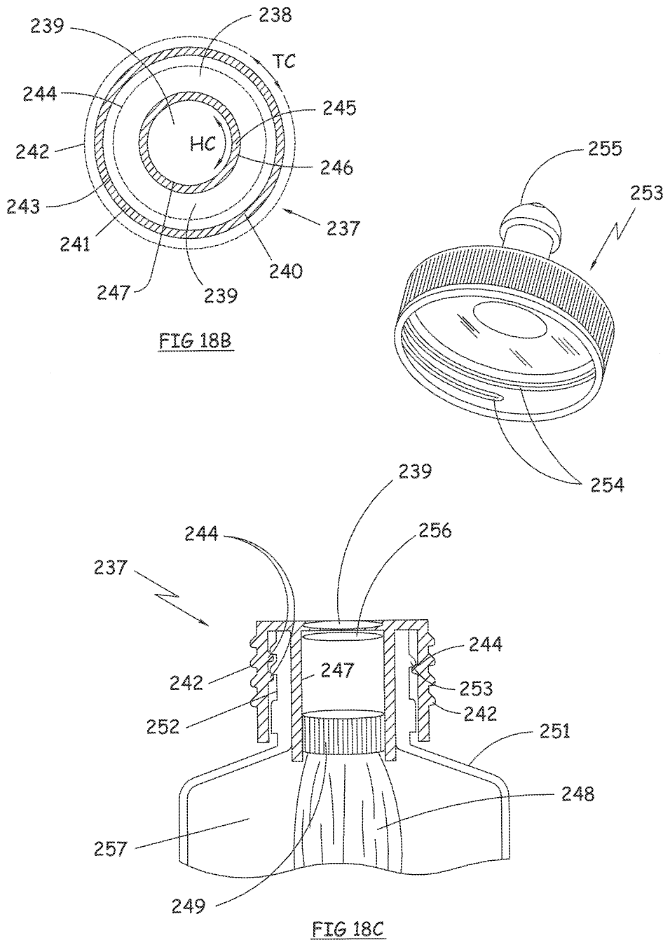

Referring to FIGS. 18A, 18B, and 18C, thereat is another practice of the fluid dispensing system of the disclosure wherein an adaptor assembly is provided, which adaptor assembly can convert standard or commercial fluid containers, such as without limitation, plastic water bottles and paperboard milk cartons, to dispensing systems that have high purity, are refillable, can dispense multiple and different fluids, and can be free of contaminants such as bisphenol A (BPA). At FIG. 18A, an embodiment of such an adaptor assembly 237 is provided. Without limitation, assembly 237 is for use with a fluid container having a hollow interior portion and at least one neck that has external threads. Such a container can comprise e.g., plastic, paperboard, and the like, such as plastic water bottles, e.g. a plastic water bottle having a closure cap, a squirt cap, a pour cap, and other dispensing caps or tubes and straws as known in the art, and milk or juice containers, such as quart or half gallon containers that comprise paperboard, e.g. plastic-coated paperboard, and that have a neck, usually plastic, with external threads for a cap or other closure. Other materials of container and container cap construction as known in the art are also contemplated.

As depicted in FIGS. 18A and 18B, adaptor assembly 237 comprises a substantially circular, preferably flat, top portion 238 that has a substantially concentric top hole 239 therethrough, which top hole 239 forms an opening that extends through top portion 238 and top hope 239 is preferably about or equal to the diameter of the neck of the fluid container for which the adaptor is to be used, e.g. the diameter of the neck of a standard or commercial bottle. The circular top portion 237 has a circumference denoted by arrows TC in FIG. 18B; similarly, top hole 238 has a circumference denoted by arrows HC in FIG. 18B. A first annular wall 240 extends downwardly from the top circumference TC of top portion 237. In the practice shown, the first annular wall 240 has a first wall outer surface 241 and a first inner wall surface 243. First wall outer surface 241 comprises a first set of threads 242, e.g. screw threads, which extend outwardly from the first outer wall surface and are configured to mate with the threads on the inner wall of the cap or dispenser for the container, (e.g. see FIG. 18C and cap 253 having internal threads 254), which include the threads on a standard or commercial container cap. The first inner wall surface 243 has a second set of threads 244 extending outwardly from the first inner wall surface and which are configured to mate with the external threads on the neck of the fluid container for which the assembly 237 is to be used, e.g. the external threads on the neck of a standard or commercial container. As depicted, the first annular wall 240 is generally cylindrically shaped.

A second annular wall 245 extends downwardly from the top hole circumference HC. As shown, the second annular wall has a second wall outer surface 246 and a second wall inner surface 247. Preferably, both the second wall outer surface 246 and the second wall inner surface 247 are substantially smooth. As depicted, second annular wall 245 is generally cylindrically shaped and is substantially parallel and concentric with, and is optionally of substantially the same length as, first annular wall 240. The second annular wall, e.g. the second wall inner surface of same, defines a passageway, e.g. of generally cylindrical shape, that is in fluid communication with, and is preferably contiguous with, top hole 239. In a preferred practice, the diameter of the passageway, denoted as Y in FIG. 18A, is about or equal to the diameter of top hole 239. The length of first annular wall 240 and second annular wall 245 can be substantially the length of the neck of the container on which adaptor assembly 237 is to be used, and can terminate, e.g. at or proximate the shoulder of such container. The second annular wall 245 is configured with the first annular wall 240, e.g. the first wall inner surface, to define a space therebetween, denoted as X in FIG. 18A, that is sufficient for receiving the neck of the fluid container on which the adaptor assembly is to be used.

Adaptor assembly 237 additionally comprises a collapsible bag 248 for containing a fluid to be dispensed. Collapsible bag 248 is configured to be disposed within the hollow interior space of the fluid container on which the adaptor assembly is to be used, and has an open end 249 from which the fluid to be dispensed egresses. In one practice, the open end 249 of collapsible bag 248 is sealed to at least a portion of the second inner wall surface, e.g. the area of the collapsible bag proximate the open end is sonically welded to a portion of the second inner wall surface, e.g. about midway up the second inner wall surface as depicted in FIG. 18A. Other methods of sealing can be employed, e.g. adhesives, in particular food grade contaminant free adhesives. Optionally, the collapsible bag 248 may comprise a collar or other connector at or under the open end 249 which collar or connector can be sealed to the second inner wall surface. Optionally, the second inner wall surface may comprise a circumferential lip (not shown) that extends into the passageway to which lip the open end of the collapsible bag may be sealed. In one practice, the fluid container on which the adaptor assembly is to be used comprises plastic or paperboard, e.g. plastic-coated paperboard as used in milk and juice cartons. In another practice, the fluid container can be plastic that comprises BPA of materials that can generate BPA, and the adaptor assembly, e.g. the top portion, the first annular wall, the second annular wall, the collapsible bag, and the dispensing cap, each individually comprise a material, such as a plastic, free of bisphenol A (BPA). Thus, for example, a standard or commercial plastic water bottle having BPA or the ability to generate BPA can be converted into a BPA-free container by use of the adaptor assembly of the disclosure.

FIG. 18C depicts, without limitation, an example of a fluid dispensing system of the disclosure using the adaptor assembly described herein. Fluid container 251, such as a plastic water bottle, has external threads 253 on its neck. The collapsible bag 248, which has had the area near or at its open end 249 previously sealed to a portion of the second inner wall surface 247, placed through the container neck opening 256 to dispose it within the hollow interior portion 257 of container 251. The adaptor assembly 237 is then screwed down over the external neck threads 253 so that these threads 253 mate with the second set of threads 244 extending outwardly from the first inner wall surface of the adaptor assembly. The fluid to be dispensed can thereafter be filled into the collapsible bag 248. Cap 253, depicted as squirt cap having a squirt nozzle 255, is then screwed down over the adaptor assembly 237 so that the first set of threads 242 mate with the internal threads 254 of cap 253. The fluid to be dispensed can then be either squirted out of cap and nozzle 255 by squeezing the container or by drawing the fluid out by mouth through nozzle 255; cap 253 can also be a closure cap wherein the fluid to be dispensed is poured out of the container.

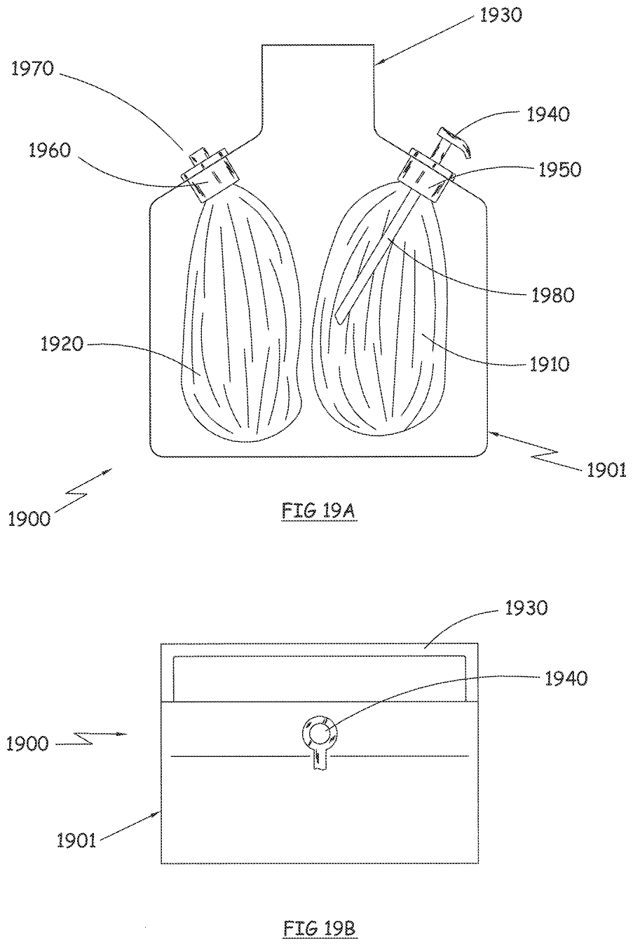

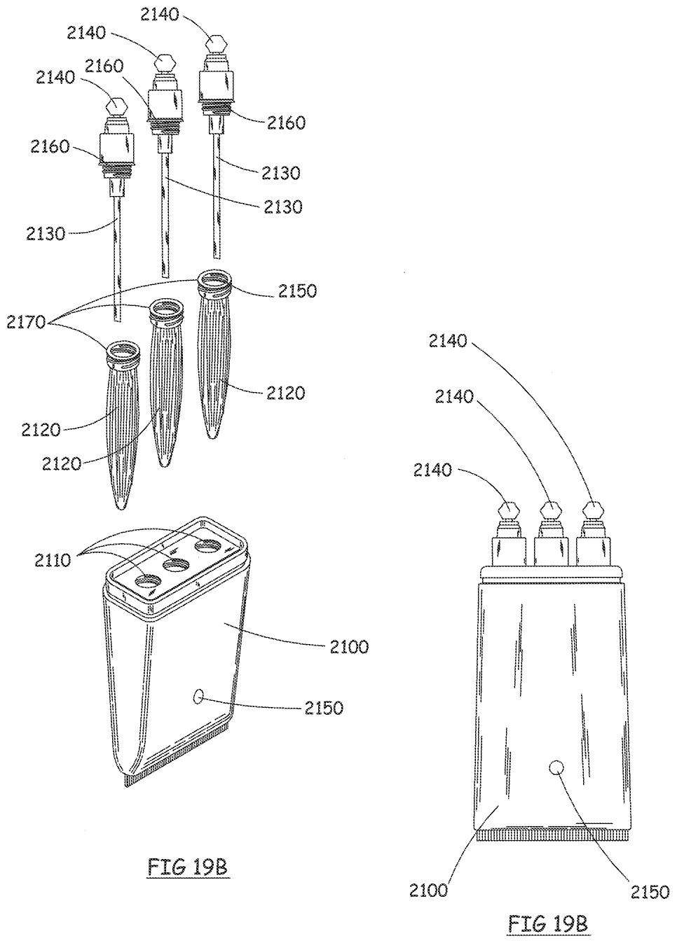

Referring to FIGS. 19A and 19B thereat is another embodiment of a fluid dispensing system of the disclosure showing a jug-like container 1900 comprising wall portion 1901 which can comprise materials herein discussed, e.g. cardboard and the like, handle 1930, collapsible fluid dispensing bags 1910 into which dip tube 1980 is disposed, and 1920 (two bags being depicted, although one such bag or a multiplicity or more than two can be used). Bags 1910 and 1920 are attached to connectors 1960 and 1950 respectively and to pump spout 1940, which employs dip tube 1980; and pour spout 1970; other types of outlets and or dips tubes for same as described herein or known are contemplated and spouts 1940 and 1970 may be the same or different. Without limitation, in one exemplified practice, bag 1920 can contain a beverage, e.g. milk, and bag 1910 can contain a flavoring agent, e.g. chocolate syrup; or e.g. bag 1920 can contain whole milk and bag 1910 can contain skim milk, each bag connected to pourable spouts.

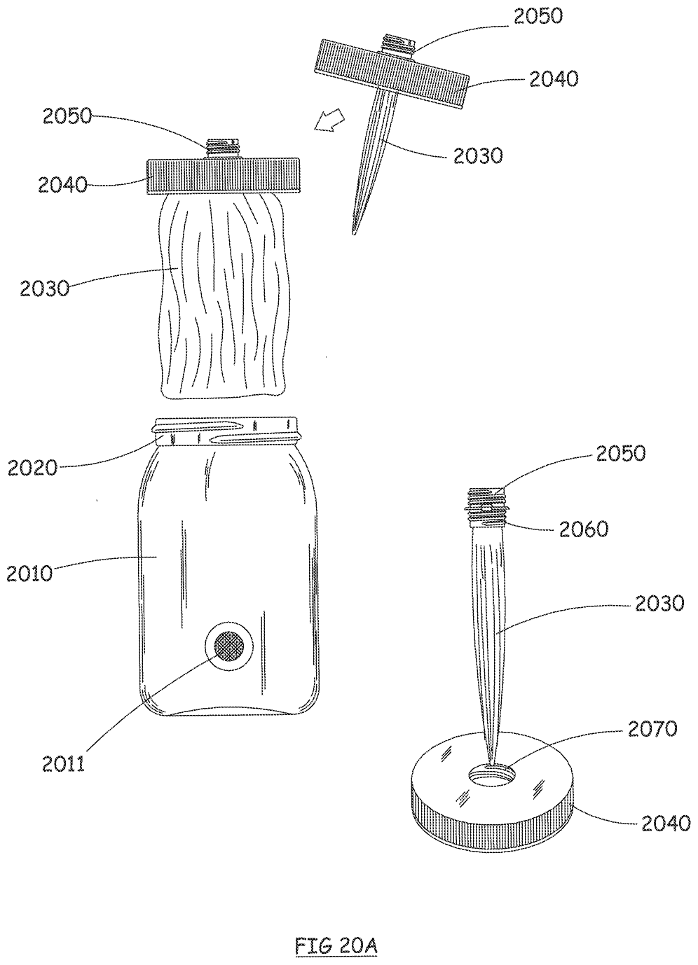

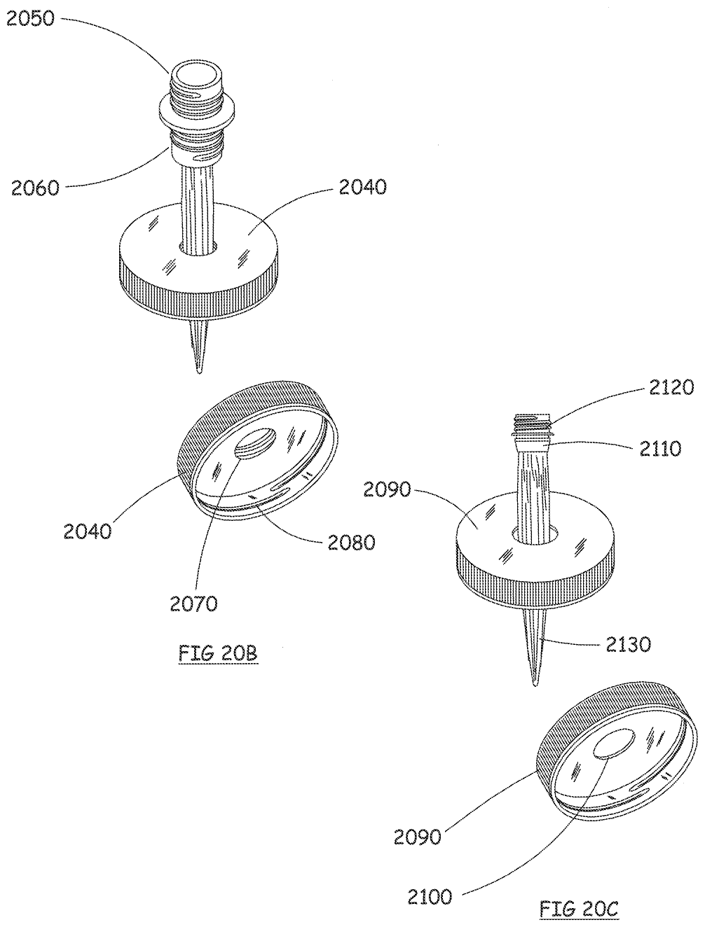

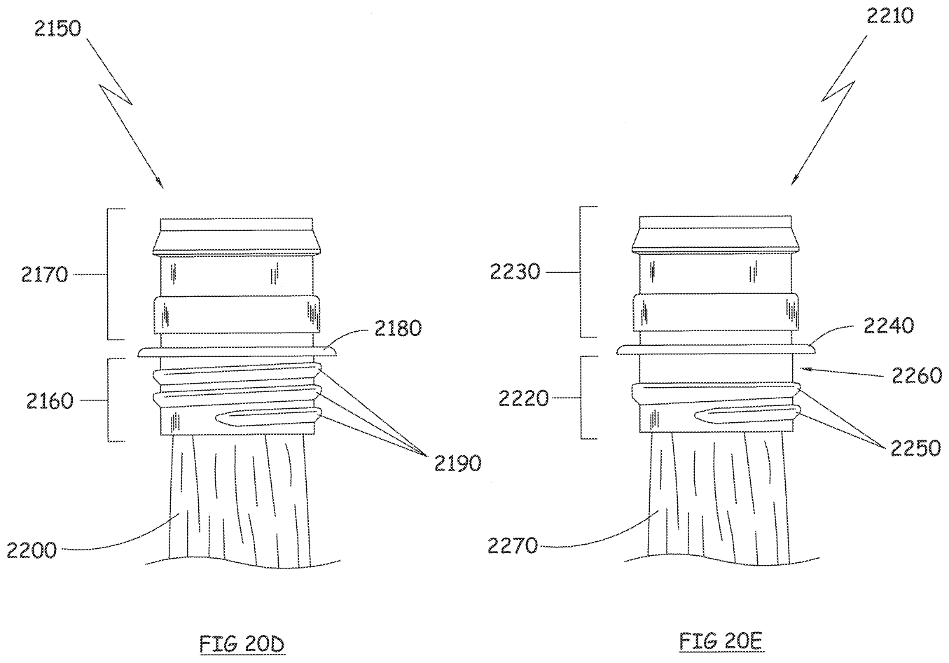

Referring to FIGS. 20A, 20B and 20C, thereat is another embodiment of the fluid dispensing system of the disclosure. FIG. 20 shows squeezable body 2010 which can be e.g. plastic or cardboard, having mesh fabric covered vent hole 2011. Squeezable body 2010 has a wide mouth neck with an open end attached to connector 2020 which connector has external threads. Lid 2040 is configured with a dispensing hole and comprises internal threads 2080 (as seen in FIG. 20B) which are adapted to mate with the external threads on connector 2020. Lid 2040 further has internal threads 2070 within its dispensing hole which are configured to mate with external threads on annular collar 2060 to which collapsible fluid dispensing bag 2030 is attached. The annular collar comprises an upper annular portion which comprises external threads 2050 which are adapted to mate with a dispensing spout or cap. In another embodiment, shown in FIG. 20C, lid 2090 has a dispensing hole that is configured to have a snap connector 2100, which snap connector is configured to mate with complementary annular collar snap connector 2100. Upper annular portion 2120 is shown having external threads 2120 which are adapted to mate with a dispensing spout or cap; however, a snap connector can be used in place of threads 2120. FIG. 20D illustrate an embodiment of a connector 2150 comprising an annular collar 2160 having a full set of external threads 2190 the extend outwardly along substantially the entire length of the annular collar, e.g. extend from flange 2180 to the end where the collapsible bag 220 is attached, and an upper annular portion 2170 configured as a snap connector. FIG. 20E illustrates another embodiment of a connector 2210 comprising an annular collar 2220 having an unthreaded portion 2260 and a set of external threads 2250 that extend from the end where collapsible bag 2270 to said unthreaded portion 2260, and a snap connector 2230. In one practice, the unthreaded portion 2260 comprises about one half the length, or less, measured from the flange 2240 to where the external threads 2250 commence. The embodiment of FIG. 20E may be employed as a self-tapping type connector and can facilitate a flat and flush fit with the container.

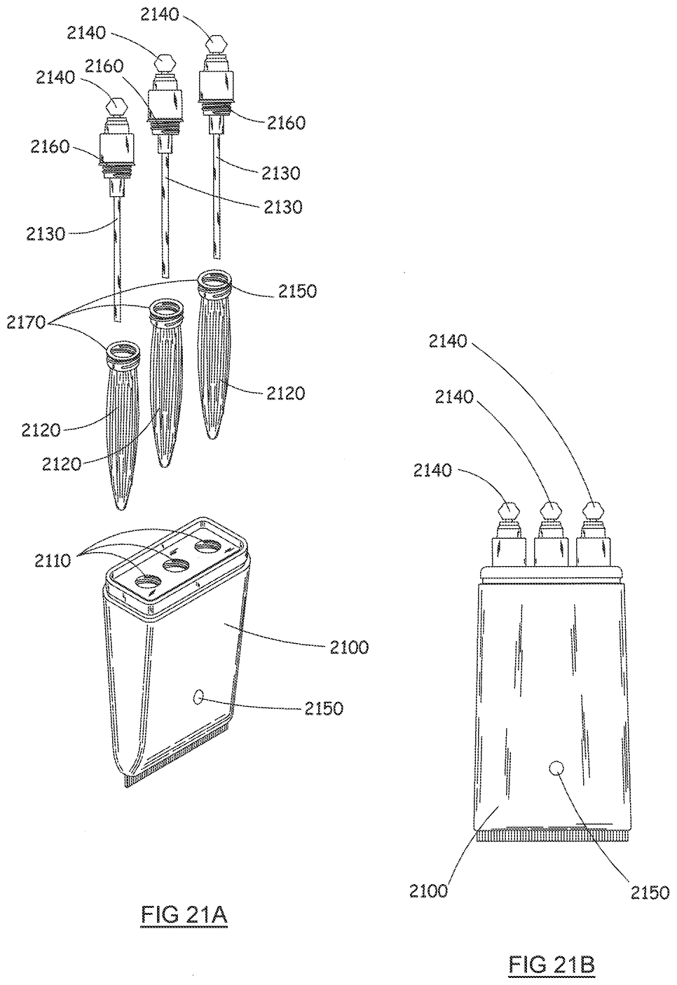

Referring to FIGS. 21A and 21B, thereat is another embodiment of the fluid dispensing system of the disclosure comprising body portion 2100 which is shown as being of a squeezable material having vent hole 2150, but can alternatively be of a substantially rigid material as described herein. As depicted, body portion 2100, which can be of any shape, e.g. tubular (not shown), has three discharge holes, 2110, but can have a lesser or greater number of discharge holes; as shown, discharge holes 2100 have threads which are adapted to mate with the external threads on connectors 2170. Snap fittings may also be used. Collapsible fluid dispensing bags 2120 are attached to connectors 2170 and inserted into body portion 2150. Straws 2130, which are in fluid communication with the squirt plug dispensers 2140 as known in the art, and which can comprise plastic and the like, are disposed into the bags 2120 which can contain fluids such as beverages, e.g. carbonated drinks, or condiments; each bag can contain the same or different fluid. Once assembled and filled, as in FIG. 21B, the squirt plugs may be pulled up as known in the art, and the beverage sipped through the plug 2140 via the straw 2130. Alternatively, the straws 2130 may be eliminated and the fluid contents can be dispensed directly from the squirt plugs 2140, which can be individually opened or closed.

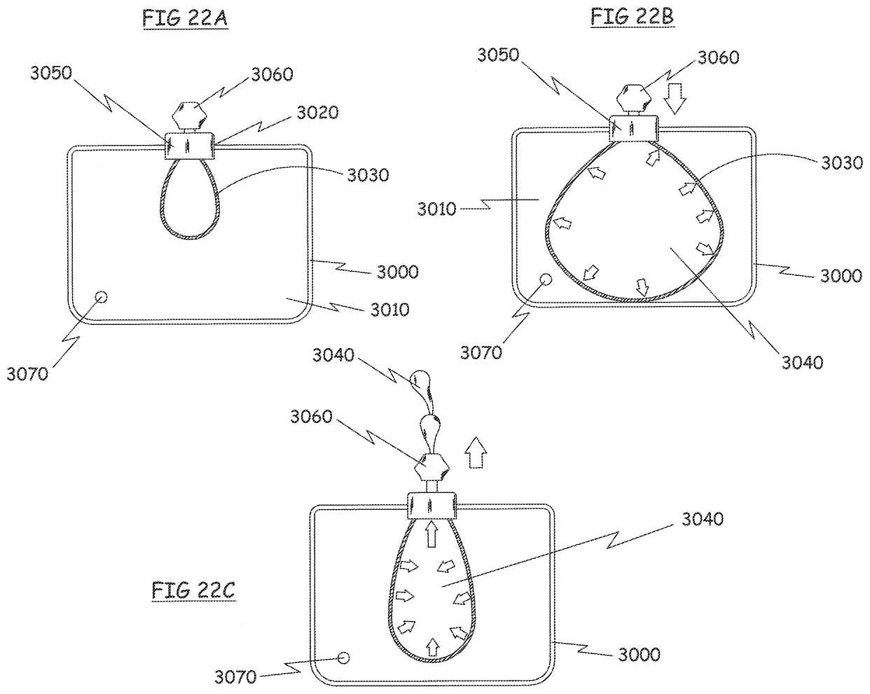

Referring to FIGS. 22A, 22B, and 22C, is another embodiment of the fluid dispensing system of the disclosure showing container 3000 which is comprised of either a substantially rigid body or a squeezable body as herein defined; the container (the substantially rigid body or squeezable body, which can be of any shape described herein or otherwise, with a rectangular shape being depicted for convenience) comprises a hollow interior space 3010 and a first discharge hole (at 3020) at a first location shown at the top surface of 3000, and optionally one or more vent holes 3070. An expandable and contractible elastic balloon 3030 for containing a fluid to dispensed 3040 is disposed within interior space 3010. As depicted, elastic balloon 3030, shown in FIG. 22A in an empty fully contracted state, has an open end that is attached to annular collar 3050, including collars as described herein, which collar can be a snap fit or thread attachment adapted to mate with first discharge hole 3020. The elastic balloon 3030 can be attached to annular collar 3050, the annular collar and its modes of attachment as described herein, including by having the open end of the balloon extend past the collar whereafter the extended portion is folded over to be in contact with the threads or snap connection of collar 3050 so as to be interposed between the collar thread or snap connection and the mating thread or snap connection of the applicator 3060 thus forming a press fit. Applicator 3060 engages the first discharge hole 3020, in this instance via collar 3050, and has a closed position (as shown in FIG. 22B) and an open position (as shown in FIG. 22C), and is configured to permit the fluid to be dispensed from the expandable and contractible elastic balloon and flow out of the applicator when the applicator is in the open position as shown in FIG. 22C. In the practice depicted, the elastic balloon is filled, including filled as described herein, with the fluid to be dispensed 3040, which causes the elastic balloon to expand (as shown in FIG. 22B). When filled or partly filled, the elastic balloon 3030 as expanded and under pressure by the fluid 3040, as shown by arrows in FIG. 22B). When applicator 3060 is moved to an open position (meaning either partly or fully opened), as shown in FIG. 22C, the balloon automatically contracts (as shown by the arrows in FIG. 22C), which contraction urges the fluid 3040 to be flow from applicator 3060. In one practice, the elastic balloon 3030 comprises materials known in the art, including without limitation, food and/or medical grade materials of construction, such as, without limitation, silicone, a BPA-free material, a sugar protein, or a milk protein, or combinations thereof. Applicator 3060 can comprise a squirt plug, a hand pump, or a spray pump, or other applicators known in the art or as described herein. The substantially rigid body or squeezable body can be opaque or can be at least partly transparent or at least partly semi-transparent. Fluids to be dispensed include those described herein. In one practice, for example where the applicator 3060 is squirt plug of the pull-push or twist type as known in the art, the user can place a finger over the plug opening to control the rate of fluid 3040 being dispensed. When a desired amount of fluid has been dispensed, the user can move the applicator to the closed position and the remaining pressure will be sufficient for further dispensing. The balloon can be refilled when empty or when pressure within is too low to dispense. Because this embodiment is pressurized as described, the fluid 3040 can be dispensed when the container is held at any angle, e.g. when the container is vertical or horizontal.

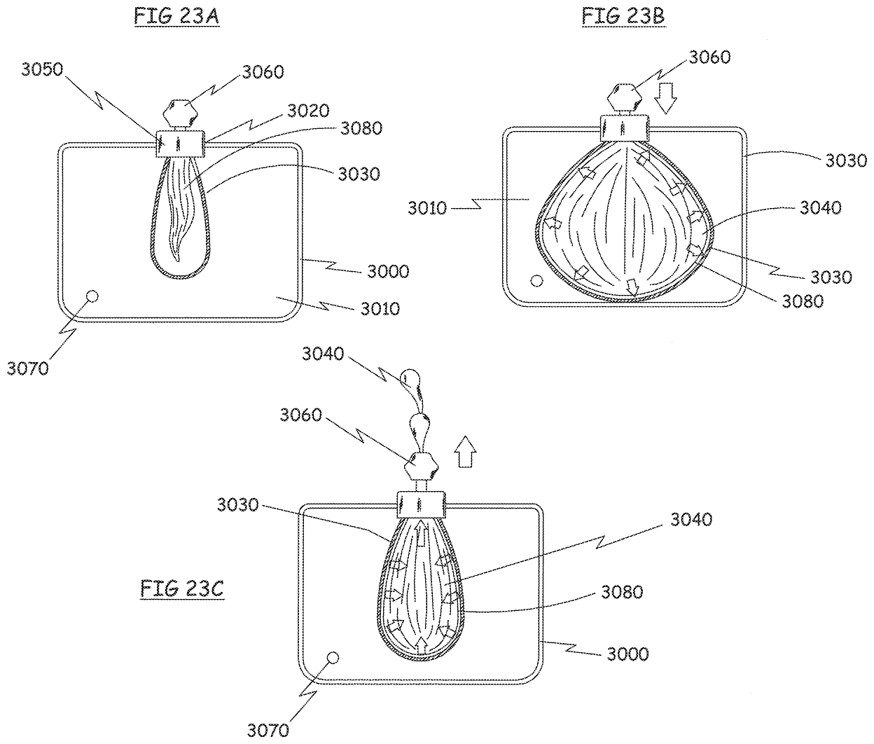

In conjunction with the practice shown in FIGS. 22A, 22B and 22C, reference is now made to FIGS. 23A, 23B, and 23C, whereat a related embodiment of the present disclosure is depicted. As shown, elastic balloon 3030 comprises a collapsible inner bag 3080, which inner collapsible bag 3080 contains the fluid to be dispensed 3040, rather than the elastic balloon itself as shown in FIG. 22. Collapsible inner bag 3040, which includes collapsible bags as described herein, comprises an inner bag open end that is overlapping or coterminous with the open end of the elastic balloon. As depicted, each of the elastic balloon 3030 and the inner bag 3080, each shown in FIG. 23A in an empty fully contracted state, has an open end that is attached to collar 3050, including collars as described herein, which collar can be a snap fit or thread attachment adapted to mate with first discharge hole 3020. The open ends of elastic balloon 3030 and inner bag 3080 can co-extensively be attached to collar 3050 as described herein, including by having the open end of the elastic balloon 3030 and the open end of the inner bag 3080, which open end of the inner bag is inside the open end of the elastic balloon, each extend past the collar whereafter the extended open end portions of the elastic balloon and inner bag are folded over to be in contact with the threads or snap connection of collar 3050 so as to be interposed between the collar thread or snap connection and the mating thread or snap connection of the applicator 3060 thus forming a press fit. Alternatively, the elastic balloon can be separately attached to the collar or to a portion of the inner surface of the container 3000 and the inner bag can be attached to the collar as herein described. Applicator 3060 engages the first discharge hole 3020, in this instance via collar 3050, and has a closed position (as shown in FIG. 23B) and an open position (as shown in FIG. 23C), and is configured to permit the fluid to be dispensed from the inner bag 3080 and flow out of the applicator when the applicator is in the open position as shown in FIG. 22C. In the practice depicted, the inner bag 3080 is filled, including filled as described herein, with the fluid to be dispensed 3040, which causes the inner bag 3080 to expand against elastic balloon 3030 which in consequence expands (as shown in FIG. 23B). When inner bag 3080 is filled or partly filled, the elastic balloon 3030 is expanded and is under pressure by the fluid 3040 in inner bag 3080, as shown by arrows in FIG. 23B). When applicator 3060 is moved to an open position (meaning either partly or fully opened), as shown in FIG. 23C, the elastic balloon 3030 automatically contracts (as shown by the arrows in FIG. 23C), thereby impinging on the collapsible inner bag sufficient to urge the fluid therein 3040 to flow out of the applicator 3060.

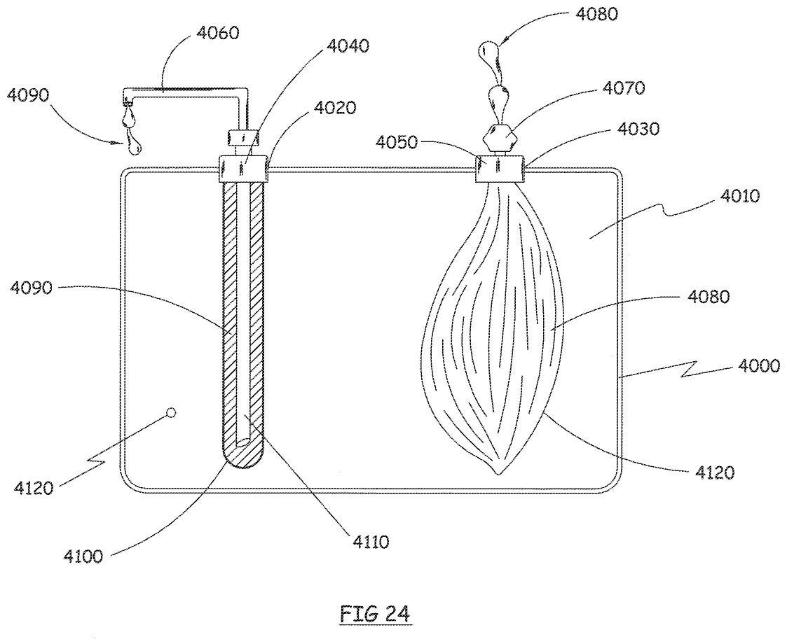

Referring to FIG. 24, thereat is another embodiment of the fluid dispensing system of the disclosure comprising a squeezable body 4000 which comprises a hollow interior space 4010, a first discharge hole 4020 at a first location (shown as being at first location at the top surface of body 4000 although other locations are contemplated) and a second discharge hole 4050 (shown as being at a second location at the top surface of body 3000 (although other locations are contemplated), with each of the first and second discharge holes 4020 and 4050 accessing the hollow interior space 4010. Body 4000 can optionally comprise one or more vent holes 4120. Collapsible bag 4120 for containing a first fluid to be dispensed 4080 is disposed within the hollow interior space 4010, the collapsible bag 4120 having an open end in fluid communication with the first discharge hole; as shown, collapsible bag 4120 is attached to annular collar 4050 as described herein. Applicator 4070, shown as a squirt plug, but other applicator embodiments as known in the art or described herein are contemplated, engages the first discharge hole 4030 for permitting the first fluid 4080 from the collapsible bag 4120 to flow from the it, when in the open position, when the squeezable body is squeezed, as described herein. A rigid or semi-rigid canister 4100 for containing a second fluid to be dispensed 4090 is also disposed within the hollow interior space 4010. Canister 4100 is attached to or unitary with connector 4040 which can include an annular collar as described herein; connector 4040 can have a snap fit connection or thread connection (internal or external) which is adapted to mate with the connection within the second discharge hole 4020. Dispensing pump 4060, which can include dispensing pumps as known in the art or as described herein e.g. a hand pump, a spray pump, etc., is in fluid communication with canister 4100 for permitting the second fluid 4090 from the canister 4100 to flow from the dispensing pump when the dispensing pump is activated. In the non-limiting practice shown, dispensing pump 4060 is in fluid communication with a dip tube 4110 which is disposed within the canister 4100 and immersed in second fluid 4090, the dispensing pump in fluid communication with the dip tube. The first fluid to be dispensed 4080 and the second fluid to be dispensed 4090 can be the same or different and can include fluids as described herein. Advantageously, when body 4000 is squeezed to provide first fluid 4080 from applicator 4070, the dip tube 4110 will not risk puncturing collapsible bag 4120 inasmuch as it is located within canister 4100.

In another practice, using FIGS. 22 and 23 as representative, the container 3000 can comprise a commercially available plastic or glass bottle, e.g. a commercially distributed ketchup glass bottle or a lotion glass bottle, or the like, can be used. Collar 3050 can be adapted to mate with the threads on the commercial glass or other commercial bottle. Advantageously, when the amount of fluid to be dispensed 3040, e.g. ketchup or lotion, is running low, the balloon 3030 (FIG. 22) or the combination of the balloon and inner bag 3080 can be removed from the bottle and the balloon or the balloon and inner bag, can be manually squeezed by the user to extract all the remaining fluid, thus avoiding the need to shake or otherwise attempt to scoop out the remaining fluid, some of which will remain within the known bottle in any event, e.g. on the inner walls of the bottle. Additionally, the instant disclosure permits the container to be refilled, thus having an ecological benefit as opposed to known bottles which are discarded after use. In another embodiment, the container 3000 can comprise cardboard as described herein, offering further ecological benefits as opposed to plastic or glass. In the other embodiments described herein, the collapsible bag can be removed and manually squeezed to extract all the remaining fluid as well, thus achieving maximum use of fluid, such as condiments, lotions and other fluids as described herein.

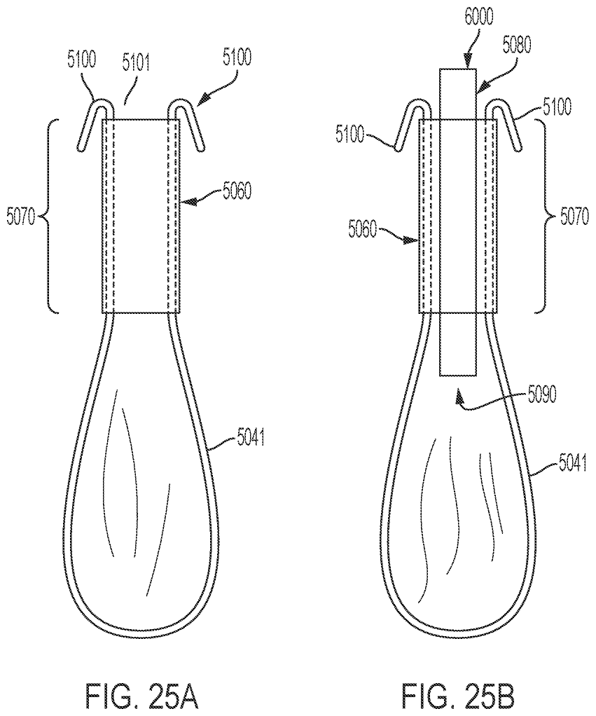

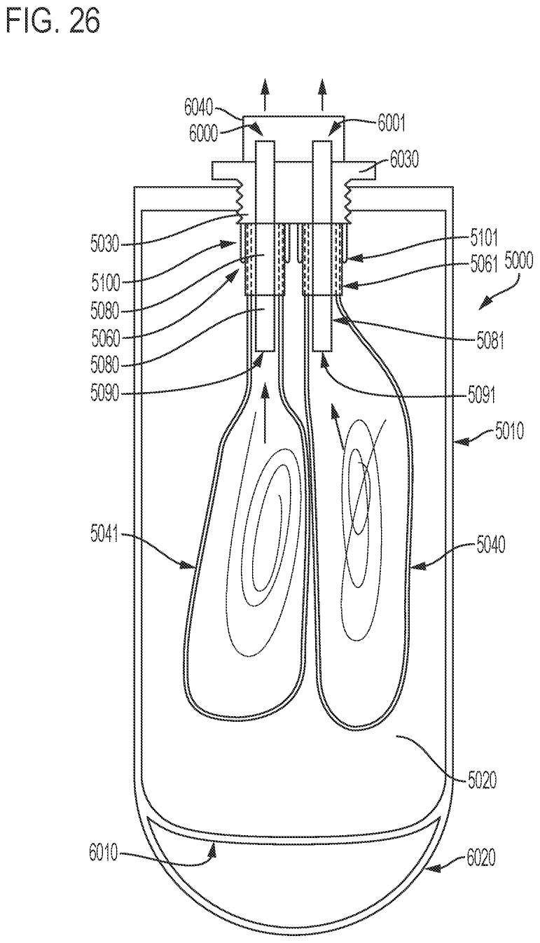

Yet another embodiment of the fluid dispensing system of the disclosure comprises a squeezable body having a hollow interior space and an open end at a first location, the open end accessing the hollow interior space; an annular collar attached to the open end; a plurality of pressure sensitive containers selected from: (a) a plurality of collapsible bags, or (b) a plurality of elastic balloons, or (c) a combination of at least one collapsible bag and at least one elastic balloon, each of (a) the plurality of collapsible bags or each of (b) the plurality of elastic balloons or each of (c) the combination of at least one collapsible bag and at least one elastic balloon contains a respective fluid to be dispensed, and each of (a) the plurality of collapsible bags or each of (b) the plurality of elastic balloons or each of (c) the combination of at least one collapsible bag and at least one elastic balloon are disposed within the interior space, and each of (a) the plurality of collapsible bags or each (b) the plurality of elastic balloons or each of (c) the combination of at least one collapsible bag and at least one elastic balloon individually having: a discharge end portion, an outer tube disposed over the discharge end portion, an inner tube disposed within the discharge end portion, the inner tube in fluid communication with the respective fluid to be dispensed, the inner tube having (i) an inner tube inlet located within the respective pressure sensitive container for intake of the respective fluid to be dispensed, and (ii) an inner tube outlet from which the respective fluid to be dispensed is dispensed, the inner tube outlet disposed within the annular collar or extending above the annular collar, the outer tube configured to provide a flush fit of the discharge end portion between it and the outside surface of the inner tube. A representative practice of this embodiment is shown at FIGS. 25A, 25B, 26, 27, and 28.

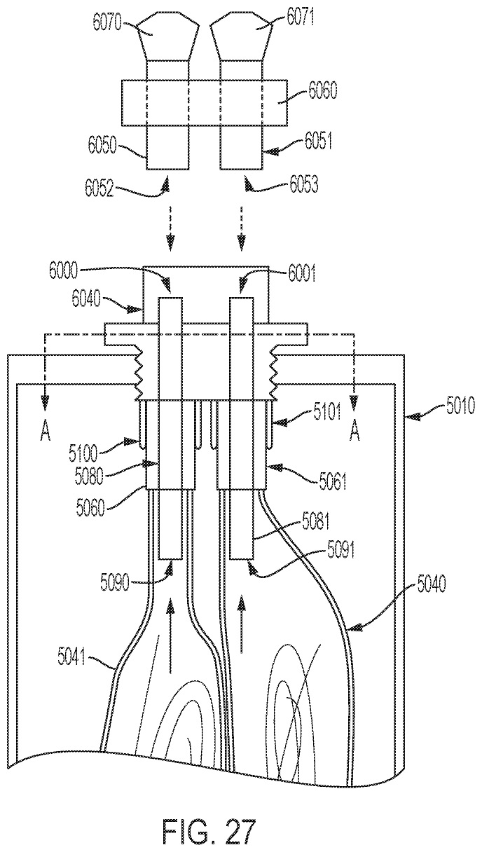

Referring to FIGS. 25A, 25B, 26, 27 and 28, and referring to the features and practices of related elements herein elsewhere described, thereat is shown a fluid dispensing system 5000 of the disclosure comprising a squeezable body 5010 which can comprise squeezable materials as described herein including without limitation the cardboard embodiments as set forth above. Squeezable body 5010 can be of any geometric shape, including without limitation a generally cylindrical shape as shown, a generally circular shape, a generally rectangular shape (which term includes generally square shapes), a generally oval shape and the like. In the figures, squeezable body 5010 is depicted as having a generally cylindrical shape having a closed end 6010 distal from to the open end (shown with annular collar 5030), and optionally a loop or other shaped member 6020 for carrying or hanging. Squeezable body 5010 has an open end at a first location and a hollow interior space 5020. An annular collar 5030 is attached to the open end (the open end shown with the annular collar attached in FIGS. 26, 27). The annular collar can comprise external threads adapted to mate with internal threads on the open end or the annular collar can have a snap fit adapted to mate with a complimentary snap fit on the open end. In the practice depicted, a plurality of collapsible bags each containing a respective fluid to be dispensed are each disposed within the hollow interior space 5020, two collapsible bags 5040 and 5041 being depicted in the practice of FIG. 27, although more than two can be employed, e.g. 2 to 4 collapsible bags or more depending upon the size of the squeezable body and accoutrements. Each collapsible bag comprises a discharge end portion 5070 as representatively shown as the cross hatched portion of collapsible bag 5041. Discharge end portion 5070 is in the practice shown proximate the discharge end opening 5101 of the collapsible bag 5041. In one aspect, the discharge end portion 5070 can comprise about 5% to about 30% of the upper length of the collapsible bag, e.g. about 10% to about 20%, about 15% and the like. It will be understood that for the sake of brevity, although the present description is for a plurality of collapsible bags that a plurality of elastic balloons or a combination of at least one collapsible bag and at least one elastic balloon can be instead employed, the details regarding the employment of collapsible bags described herein being directly applicable to the employment of elastic balloons. As described herein, in one practice, the fluid contents of the elastic balloons can be dispensed by merely opening the applicator, e.g. by pulling open the push-pull squirt; the flow of dispensed fluid in this regard can be controlled by the extent to which the push-pull squirt plug has been opened. For a full flow, the plug is opened all the way; for a lesser flow, the plug is only partially opened. An outer tube 5060 is disposed over the discharge end portion 5070, e.g. by slipping discharge end portion 5070 through outer tube 5060. Inner tube 5080 is disposed within the discharge end portion and is in fluid flow communication with the fluid to be dispensed in collapsible bag 5041. Inner tube 5080 comprises an inner tube inlet 5090 located within the collapsible bag for intake of the fluid to be dispensed (fluid flow being shown by arrows into inlet 5090 in FIG. 26), and an inner tube outlet 6000 from which the fluid to be dispensed exits. In one practice, the inner tube outlet 6000 is disposed within the annular collar 5030 or extends above the annular collar as shown in FIG. 26; other configurations for the inner tube outlet 6000 relative to the annular collar can be employed. In another practice, the outer tube 5060 is configured so as to provide a flush fit of the discharge end portion 5070 between it (the inside surface of outer tube 5060) and the outside surface of inner tube 5080, e.g. the discharge end portion is tightly placed and substantially immobile between the outer tube 5060 and inner tube 5080. In one practice, outer tube 5060 has a length less than the length of inner tube 5080.

In one practice, an upper section 5100 of collapsible bag 5041 integral with the discharge end portion 5070 extends beyond the outer tube 5060 and is folded over as shown in FIGS. 25A, 25B; in one embodiment, upper section 5100 is folded over to be in contact so as to be in contact with the outside surface of outer tube 5060, as shown in FIG. 26. In one instance, the folded over upper portion 5100 is secured to the outside surface of outer tube 506 by an adhesive or other means known in the art. For the practice shown, e.g. in FIG. 26, each collapsible bag (5040, 5042), each inner tube (5080, 5081), each outer tube (5060, 5061), and the adhesive employed to secure folded upper section 5100 to the outside surface of each outer tube can comprise a food grade material of construction. In one practice, the fluid to be dispensed within each collapsible bag comprises a condiment, which can be the same or different among the plurality of collapsible bags; for example, one bag (5040) can contain ketchup, the second bag (5041) can contain mustard. In this instance, when squeezable body 5010 is squeezed, the ketchup and mustard are dispensed substantially side by side to form stripes or other visual patterns.

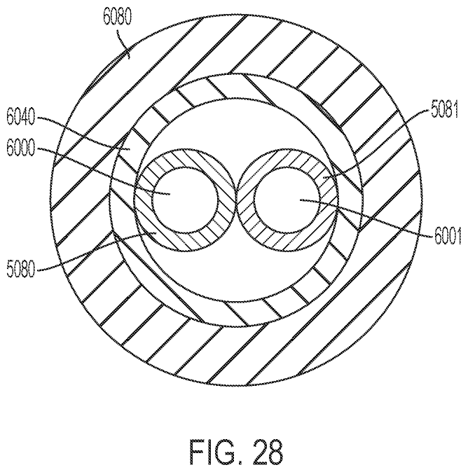

In one embodiment, the annular collar 5030 has a top surface that comprises a planar circumferential flange 6030. The annular collar 5030 can further comprise an upper annular portion 6040 that extends coaxially from the annular collar 5030 and above the flange 6030. In various instances, the annular collar 5030 and the upper annular portion 6040 can each be separate pieces joined by sonic welding, heat sealing, or adhesive; or they can be integrally formed. FIGS. 27 and 28 depict an embodiment wherein two collapsible bags 5040, 5041, are deployed. Each respective bag has its own outer tube (5060. 5061), its own inner tube (5080, 5081), its own folded over upper upper section (5100, 5101). In one practice, the fluid dispensing system 5000 can be used by squeezing body 5010 sufficient to urge the respective fluids in bags 5040, 5041 to be dispensed through inner tube outlets 6000, 6001 without any further attachments except for an optional cap. In another practice, the upper annular portion 6040 can comprise a snap fit connector, internal threads, or external threads, each of which are configured for attachment to a respective applicator or closed end cap. In one aspect, as representatively shown in FIG. 27, a cap 6060 can comprise plurality of discharge tubes 6050, 6051 equal to the number of collapsible bags 5040, 5041, wherein each discharge tube has a discharge tube inlet 6052, 6053, configured to mate with the respective inner tube outlets 6000, 6001, e.g. by sliding over them or int39o them or by other means known in the art. Each discharge tube further ahs a discharge tube outlet, which in the case of FIG. 27 are respectively connected to applicators 6070, 6071, which can have open and closed positions and can be squirt plugs as shown in FIG. 27 or other applicators as known in the art. Squirt plugs as used herein includes without limitation push-pull plug which when in the open position can be the entry point for refilling respective collapsible bags and elastic balloons.

FIG. 28 shows a top view of section A-A in FIG. 27 and depicts circumferential flange 6080, upper annular portion 6040, and inner tubes 5080, 5081 with inner tube outlets 6000, 6001. The inner tubes 5080, 5081, and/or outer tubes 5060, 5061 (two being shown but a higher plurality contemplated) can be secured in annular collar by compression fit or other means known in the art.

In one aspect, the plurality of collapsible bags or the plurality of elastic balloons can be filled with their respective fluids to be dispensed by techniques described herein, including without limitation, providing a source of the respective fluid and, for example, a filling tube with a tip suitable to mate with a push-pull squirt plug with in the open position, the fluid then caused to flow from the source through the push-pull squirt plug and into the respective collapsible bag or elastic balloon. In another practice, the collapsible bags can be placed adjacent to one another and/or the elastic balloons can be placed adjacent to one another; the fluid contents of the collapsible bags can thus be dispensed by squeezing only a portion of the squeezable body whereas the fluid contents of the elastic balloons, which are under pressure of the expanded elastic balloon can be dispensed by opening the respective applicator or cap.

The foregoing description is by way of description only and is not limiting to the disclosure.

What is claimed is:

1. A fluid dispensing system comprising:
a squeezable body having a hollow interior space and an open end at a first location, the open end accessing the hollow interior space;
an annular collar attached to the open end;
a plurality of pressure sensitive containers selected from:
(a) a plurality of collapsible bags, or
(b) a plurality of elastic balloons, or
(c) a combination of at least one collapsible bag and at least one elastic balloon,
each of (a) the plurality of collapsible bags or each of (b) the plurality of elastic balloons or each of (c) the combination of at least one collapsible bag and at least one elastic balloon contains a respective fluid to be dispensed, and
each of (a) the plurality of collapsible bags or each of (b) the plurality of elastic balloons or each of (c) the combination of at least one collapsible bag and at least one elastic balloon are disposed within the interior space, and each of (a) the plurality of collapsible bags or each (b) the plurality of elastic balloons or each of (c) the combination of at least one collapsible bag and at least one elastic balloon individually having:
a discharge end portion,
an outer tube disposed over the discharge end portion,
an inner tube disposed within the discharge end portion, the inner tube in fluid communication with the respective fluid to be dispensed, the inner tube having (i) an inner tube inlet located within the respective pressure sensitive container for intake of the respective fluid to be dispensed, and (ii) an inner tube outlet from which the respective fluid to be dispensed is dispensed, the inner tube outlet disposed within the annular collar or extending above the annular collar, the outer tube configured to provide a flush fit of the discharge end portion between it and the outside surface of the inner tube.

2. The fluid dispensing system of claim 1 wherein the discharge end portion of the respective pressure sensitive container comprises an upper section that extends beyond the outer tube and is folded over the outer tube so as to be in contact with the outside surface of the outer tube.

3. The fluid dispensing system of claim 2 wherein the folded over upper section is secured to the outside surface of the outer tube by adhesive.

4. The fluid dispensing system of claim 1 wherein the outer tube has a length less than the length of the inner tube.

5. The fluid dispensing system of claim 3 wherein each of the pressure sensitive containers, each inner tube, each outer tube, and the adhesive each individually comprise a food grade material of construction.

6. The fluid dispensing system of claim 1 wherein the fluid to be dispensed within each of the pressure sensitive containers comprises a condiment, which can be the same or different among the plurality of pressure sensitive containers.

7. The fluid dispensing system of claim 6 wherein at least two of the condiments are different.

8. The fluid dispensing system of claim 1 wherein the squeezable body has a generally cylindrical shape, a generally rectangular shape, a generally circular shape, a generally oval shape.

9. The fluid dispensing system of claim 8 wherein the squeezable body comprises a closed end distal to the open end.

10. The fluid dispensing system of claim 8 comprising a loop-shaped handle member at the distal end.

11. The fluid dispensing system of claim 1 wherein the plurality of the pressure sensitive containers (a) comprises 2 to 4 collapsible bags; or the plurality of the pressure sensitive containers (b) comprises 2 to 4 elastic balloons; or (c) a combination of 1 to 3 collapsible bags and 1 elastic balloon or a combination of 1 collapsible bag and 1 to 3 elastic balloons.

12. The fluid dispensing system of claim 1 wherein the open end comprises internal threads and the annular collar comprises external threads adapted to mate with the internal threads of the open end.

13. The fluid dispensing system of claim 12 wherein the annular collar has a top surface comprising a circumferential flange that is substantially coplanar with the top surface of the annular collar.

14. The fluid dispensing system of claim 13 wherein the annular collar further comprises an upper annular portion extending coaxially from the top surface.

15. The fluid dispensing system of claim 14 wherein the annular collar and the upper annular portion (i) are each separate pieces joined by sonic welding, heat sealing, or adhesive; or (ii) are integrally formed.

16. The fluid dispensing system of claim 14 wherein the upper annular portion comprises a snap fit connector, internal threads, or external threads, each configured for attachment to a respective applicator or cap.

17. The fluid dispensing system of claim 16 wherein the applicator or cap comprise a plurality of discharge tubes equal to the number of pressure sensitive containers, each discharge tube having (i) a discharge tube inlet configured to mate with a respective inner tube outlet and (ii) a discharge tube outlet from which the respective fluid to be dispensed is dispensed.

18. The fluid dispensing system of claim 16 wherein the respective applicator has an open and closed position.

19. The fluid dispensing system of claim 18 wherein the respective applicator comprises a push-pull squirt plug.

20. The fluid dispensing system of claim 1 wherein the plurality of pressure sensitive containers selected from (a) the plurality of collapsible bags.

21. The fluid dispensing system of claim 1 wherein the plurality of pressure sensitive containers selected from (b) the plurality of elastic balloons.

22. The fluid dispensing system of claim 1 wherein the plurality of pressure sensitive containers selected from a combination of (c) at least one collapsible bag and at least one elastic balloon.

23. The fluid dispensing system of claim 1 wherein the squeezable body comprises a vent hole.

24. The fluid dispensing system of claim 1 wherein the squeezable body comprises cardboard.
